(19) United States
(12) Patent Application Publication
(10) Pub. No.: US 2006/0232017 A1
(43) Pub. Date: Oct. 19, 2006

(54) Metal gasket for cylinder head

(76) Inventors: Yoshiaki Hamada, Saitama City (JP); Takashi Yajima, Saitama City (JP); Yasunori Murakami, Wako City (JP); Takashi Katsurai, Wako City (JP); Masamune Tabata, Wako City (JP)

Correspondence Address: YOUNG & THOMPSON, 745 SOUTH 23RD STREET, 2ND FLOOR, ARLINGTON, VA, 22202, US

(21) Appl. No.: 10/550,010

(22) PCT Filed: Mar. 17, 2004
(86) PCT No.: PCT/JP04/03609

§ 371 Date: Feb. 10, 2006

(30) Foreign Application Priority Data
Mar. 17, 2003 (JP) 2003-072730

(51) Int. Cl. F02F 11/00

(52) U.S. Cl. 277/594

(57) ABSTRACT

A metal gasket for a cylinder head has two base plates each constructed from a metal plate and layered over each other, an auxiliary plate constructed from a metal plate and interposed between the base plates, and hard metal-plated layers. The base plates each have cylinder holes, annular beads, coolant holes, and an outer peripheral bead. The cylinder holes correspond with the bore of each cylinder. The annular beads have an angled cross-sectional shape. The coolant holes correspond with a coolant jacket of the cylinder block and with a coolant hole of the cylinder head. The outer peripheral bead has a cross-sectional shape sloping on one side and surrounds the beads and the coolant holes. Each of the layers is extended from a position more radially inward than an annular bead of a base plate to a position radially outward.

### TECHNICAL FIELD

This invention relates to a metal gasket for a cylinder head to be interposed between a cylinder block and a cylinder head of an internal combustion engine.

### BACKGROUND ART

As a metal gasket of this type, for example, there is known a metal gasket including two base plates respectively made of metal plates, and an auxiliary plate having a thinner plate thickness than those base plates and interposed between those base plates, in which each of the base plates includes cylinder holes formed so as to correspond to respective cylinder bores of a cylinder block of an internal combustion engine, annular beads of an angled cross-sectional shape formed around the respective cylinder holes, and coolant holes formed on outer peripheral portions of the respective annular beads so as to correspond to coolant jackets on the cylinder block and to coolant holes on a cylinder head of the internal combustion engine, while the auxiliary plate includes cylinder holes and coolant holes as similar to those formed on the base plates. In this metal gasket, the auxiliary plate may be provided with a step structure configured to increase the thickness of cylinder hole peripheral portions overlapping the annular beads around the respective cylinder holes on the base plates as compared to outer portions located further outside so as to raise line pressures of the annular beads of the base plates and thereby to improve a sealing performance against combustion gas inside cylinders.

As the step structure, there has been conventionally known a step structure S1 as shown in FIG. 29, for example, in which an auxiliary plate 3 to be interposed between two base plates 2 respectively made of steel plates (such as SUS 301H 0.2t) is formed of thin steel plates (such as SUS 301H 0.2t or 0.3t) having different plate thicknesses between a cylinder hole peripheral portion 3a overlapping an annular bead 2b around each cylinder hole 2a on each base plate 2 and an outer portion 3b located on outside thereof so as to provide a given step, and the cylinder hole peripheral portion 3a and the outer portion 3b are joined together by laser welding (see Japanese Unexamined Patent Publication No. 7(1995)-243531, FIG. 3, for example). Here, reference numeral 1 in the drawing denotes a metal gasket, and reference code LW denotes a laser-welded portion.

Meanwhile, there has also been known a step structure S2 as shown in FIG. 30, for example, in which an auxiliary plate 3 made of a thin steel plate having a single plate thickness (such as SUS 301H 0.1t) to be interposed between two base plates 2 respectively made of steel plates. Here, the auxiliary plate 3 is provided with a given step by stacking a shim plate 4 also made of a thin steel plate. (such as SUS 301H 0.1t) on a cylinder hole peripheral portion 3a overlapping an annular bead 2b around each cylinder hole 2a on each base plate 2, and the auxiliary plate 3 and the shim plate 4 are joined together by laser welding (see Japanese Unexamined Patent Publication No. 10(1998)-61772, for example).

In addition, there has also been known a step structure S3 as shown in FIG. 31, for example, in which an auxiliary plate 3 made of a thin steel plate having a single plate thickness (such as SUS 301H 0.05t) to be interposed between two base plates 2 respectively made of steel plates. Here, the auxiliary plate 3 is provided with a given step by forming a folded portion 3c at a cylinder hole peripheral portion 3a overlapping an annular bead 2b around each cylinder hole 2a on each base plate 2 in accordance with a bending and folding process (see Japanese Unexamined Patent Publication No. 8(1996)-121597, FIG. 4, for example).

However, in the conventional step structure S1 described in the first place, it is difficult to align the cylinder hole peripheral portions 3a with the outer portions 3b to form a predetermined gasket shape. Accordingly, there has been a problem that a gasket becomes expensive because an exclusive alignment jig and a high-precision laser welding machine are indispensable for satisfying high precision required in the gasket shape.

Meanwhile, in the conventional step structure S2 described in the second place, the plate thickness of the shim plate 4 is equivalent to the amount of the step and the plate thickness of the thin steel plate distributed in the industry is incremented by 50 μm (0.05 mm) at present. Therefore, it is not possible to set the amount of the step at high accuracy in the 10-μm (0.01-mm) order and it is also difficult to ensure the function of the step with a thin plate having the thickness equal to or below 100 μm due to occurrence of distortion, deformation or a lift caused by laser welding. Moreover, an exclusive alignment jig and a high-precision laser welding machine are indispensable as similar to the first step structure. Accordingly, there has been a problem that a gasket becomes expensive.

Meanwhile, in the conventional step structure S3 described in the third place, the thin steel plate having the single plate thickness is subjected to the bending and folding process and the plate thickness becomes equal to the amount of the gap. Therefore, it is not possible to set the amount of the step at high accuracy in the 10-μm (0.01-mm) order as similar to the second step structure S2. In addition, the bending and folding process is carried out by use of a drawing process, and the degree of freedom is reduced in terms of the shape of the folded portion 3c. Accordingly, there has been a problem that it is difficult to form the folded portion 3c having a sufficient width in a radial direction without causing cracks especially by use of the thin steel plate.

Moreover, as a metal gasket of this type, there has been conventionally known a metal gasket 1 as shown in FIG. 32, for example, which includes a base plate 2 made of a metal thin plate, and rubber layers 5 as surface sealing layers made of NBR, fluorine rubber, silicon rubber or the like, which are attached to both surfaces of the base plate 2 with an adhesive 4 so as to cover the entire surfaces of the base plate 2 (see Japanese Unexamined Patent Publication No. 2(1990)-38760 and the attached drawings, for example).

Furthermore, there has also been conventionally known a metal gasket 1 as shown in FIG. 33, for example, which includes a base plate 2 made of a metal thin plate, and solid lubricant layers 6 as surface sealing layers formed by mixing graphite or molybdenum disulfide powder with a small amount of binder (resin or rubber), which are coated on both surfaces of the base plate 2 so as to cover the entire surfaces of the base plate 2 (see Japanese Unexamined Patent Publication No. 5(1993)-17737, for example).

However, in the former conventional metal gasket, the surface sealing layer is made of a rubber material and durability is therefore insufficient under a high temperature environment. Accordingly, there has been a problem that the rubber material may be decomposed or peeled off when continuously used in an environment equal to or above 200° C.

Meanwhile, in the latter conventional metal gasket, the surface sealing layer is made of a solid lubricant material and it is difficult to retain a uniform layer on the surface of the base plate. Accordingly, there have been problems that it is difficult to ensure a sufficient sealing property and that the degree of freedom of a bead structure is also reduced.

### DISCLOSURE OF THE INVENTION

An object of a metal gasket for a cylinder head according to a first aspect of this invention is to provide an excellent metal gasket capable of solving the foregoing problems advantageously, which is low in price and high in the freedom in controlling an amount of a step. The metal gasket of this first aspect includes two base plates respectively made of metal plates and layered over each other, each of which includes cylinder holes formed so as to correspond to respective cylinder bores on a cylinder block of an internal combustion engine, annular beads of an angled cross-sectional shape formed around the respective cylinder holes, coolant holes formed on outer peripheral portions of the respective annular beads so as to correspond to coolant jackets on the cylinder block and to coolant holes on a cylinder head of the internal combustion engine, and an outer peripheral bead having a cross-sectional shape sloping on one side and being formed in a position so as to totally surround the annular beads and the coolant holes. The metal gasket also includes an auxiliary plate made of a metal plate and interposed between the two base plates, and a hard metal-plated layer formed on at least one surface of the auxiliary plate and configured to extend from a position more radially inward than the annular bead to a position radially outward so as to overlap each of the annular beads of the base plate and to face a top portion of the annular bead, and thereby to surround each of the cylinder holes on the base plate annularly.

According to the metal gasket for a cylinder head described above, the hard metal-plated layer formed on at least one surface of the auxiliary plate interposed between the two base plates extends from the position more radially inward than each of the annular beads of the base plate to the position radially outward so as to overlap the annular bead of the base plate and to face the top portion of the annular bead, and thereby constitutes a step structure by annularly surrounding the respective cylinder holes on the base plates. Therefore, line pressure to be applied to the top portions of the annular beads on the two base plates is increased, and it is possible to exert a high sealing performance against combustion gas pressure inside the cylinder bores. Moreover, according to this metal gasket, the hard metal-plated layer is made of metal. Therefore, it is possible to maintain the high sealing performance as the step structure for the annular beads around the cylinder holes exposed to high heat in particular. Meanwhile, since the hard metal-plated layer is formed in accordance with a plating process, it is also easy to adjust the thickness thereof. In this way, it is possible to obtain an amount of the step easily for optimizing balance of constriction forces between the annular bead and the outer peripheral bead.

Here, in the metal gasket of this invention, an annular bead having an angled cross-sectional shape may be formed on the auxiliary plate so as to overlap the annular bead on the base plate and to allow top positions to face each other. The annular beads are stacked in three layers in this configuration, and it is possible to obtain a higher sealing performance.

Meanwhile, a metal gasket of this invention includes two base plates respectively made of metal plates and layered over each other, each of which includes cylinder holes formed so as to correspond to respective cylinder bores on a cylinder block of an internal combustion engine, annular beads of an angled cross-sectional shape formed around the respective cylinder holes, coolant holes formed on outer peripheral portions of the respective annular beads so as to correspond to coolant jackets on the cylinder block and to coolant holes on a cylinder head of the internal combustion engine, and an outer peripheral bead having a cross-sectional shape sloping on one side and being formed in a position so as to totally surround the annular beads and the coolant holes. The metal gasket also includes a hard metal-plated layer formed on either one or both of the two base plates on a surface facing the other base plate and configured to extend from a position more radially inward than the annular bead to a position radially outward so as to overlap each of the annular beads of the base plate and to face a top portion of the annular bead, and thereby to surround each of the cylinder holes on the base plate annularly.

According to the metal gasket for a cylinder head described above, the hard metal-plated layer formed on either one or both of the two base plates on the surface facing the other base plate extends from the position more radially inward than the annular bead to the position radially outward so as to overlap each of the annular beads of the base plate and to face the top portion of the annular bead, and thereby constitutes a step structure by annularly surrounding the respective cylinder holes on the base plates. Therefore, line pressure to be applied to the top portions of the annular beads on the two base plates is increased even in the case of the metal gasket including the two sheets, and it is possible to exert a high sealing performance against combustion gas pressure inside the cylinder bores. Moreover, according to this metal gasket, the hard metal-plated layer is made of metal. Therefore, it is possible to maintain the high sealing performance as the step structure for the annular beads around the cylinder holes exposed to high heat in particular. Meanwhile, since the hard metal-plated layer is formed in accordance with the plating process, it is also easy to adjust the thickness thereof. In this way, it is possible to obtain an amount of the step easily for optimizing balance of constriction forces between the annular bead and the outer peripheral bead.

In this invention, the hard metal-plated layer is preferably made of any of nickel, nickel-phosphorus, and copper, and preferably has the hardness equal to or above Hv 60, because the hard metal-plated layer can bear the high line pressure applied to the top portions of the annular beads of the two base plates without crushing and thereby prevent degradation of the sealing performance.

Meanwhile, in this invention, distribution of the amount of the step of the hard metal-plated layer relevant to the plurality of cylinder holes preferably corresponds to distribution of rigidity of the internal combustion engine relevant to the plurality of cylinder bores, because the sealing performance is well balanced by increasing the amount of the step at a less rigid portion of the internal combustion engine as compared to a more rigid portion.

An object of a metal gasket for a cylinder head according to a second aspect of this invention is also to provide an excellent metal gasket capable of solving the foregoing problems advantageously, which is low in price and high in the freedom in controlling an amount of a step. The metal gasket of this second aspect includes two base plates respectively made of metal plates and layered over each other, each of which includes cylinder holes formed so as to correspond to respective cylinder bores on a cylinder block of an internal combustion engine, annular beads of an angled cross-sectional shape formed around the respective cylinder holes, coolant holes formed on outer peripheral portions of the respective annular beads so as to correspond to coolant jackets on the cylinder block and to coolant holes on a cylinder head of the internal combustion engine, and an outer peripheral bead having a cross-sectional shape sloping on one side and being formed in a position so as to totally surround the annular beads and the coolant holes. The metal gasket also includes an auxiliary plate made of a metal plate and interposed between the two base plates, a metal foil layer made of a metal foil to be attached onto at least one surface of the auxiliary plate and configured to extend from a position more radially inward than the annular bead to a position radially outward so as to overlap each of the annular beads of the base plate and to face a top portion of the annular bead and thereby to surround each of the cylinder holes on the base plate annularly, and an adhesive layer made of an adhesive to attach the metal foil to the auxiliary plate while at least being pressurized.

According to the metal gasket for a cylinder head described above, the metal foil layer made of the metal foil pressurized and attached to at least one surface of the auxiliary plate interposed between the two base plates extends together with the adhesive layer made of the adhesive for attaching the metal foil layer from the position more radially inward than each of the annular beads of the base plate to the position radially outward so as to overlap the annular bead of the base plate and to face the top portion of the annular bead, and thereby constitutes a step structure by annularly surrounding the respective cylinder holes on the base plates. Therefore, line pressure to be applied to the top portions of the annular beads on the two base plates is increased, and it is possible to exert a high sealing performance against combustion gas pressure inside the cylinder bores. Moreover, according to this metal gasket, the adhesive constituting the adhesive layer attaches the metal foil layer to the auxiliary plate while at least being pressurized. Therefore, it is possible to form the step structure in a desired thickness easily either by pressing and allowing the adhesive layer to flow under the metal foil or by extruding part of the adhesive from under the metal foil, and to obtain an amount of the step easily for optimizing balance of constriction forces between the annular bead and the outer peripheral bead.

Here, in the metal gasket of this invention, an annular bead having an angled cross-sectional shape may be formed on the auxiliary plate so as to overlap the annular bead on the base plate and to allow top positions to face each other. The annular beads are stacked in three layers in this configuration, and it is possible to obtain a higher sealing performance. Incidentally, attachment of the metal foil may take place either before or after formation of the annular beads. However, attachment is preferably performed before the formation because the metal foil is accurately aligned with the annular beads.

Meanwhile, a metal gasket of this invention includes two base plates respectively made of metal plates and layered over each other, each of which includes cylinder holes formed so as to correspond to respective cylinder bores on a cylinder block of an internal combustion engine, annular beads of an angled cross-sectional shape formed around the respective cylinder holes, coolant holes formed on outer peripheral portions of the respective annular beads so as to correspond to coolant jackets on the cylinder block and to coolant holes on a cylinder head of the internal combustion engine, and an outer peripheral bead having a cross-sectional shape sloping on one side and being formed in a position so as to totally surround the annular beads and the coolant holes. The metal gasket also includes a metal foil layer made of a metal foil, attached onto either one or both of the two base plates on a surface facing the other base plate, and configured to extend from a position more radially inward than the annular bead to a position radially outward so as to overlap each of the annular beads of the base plate and to face a top portion of the annular bead and thereby to surround each of the cylinder holes on the base plate annularly, and an adhesive layer made of an adhesive to attach the metal foil to the auxiliary plate while at least being pressurized.

According to the metal gasket for a cylinder head described above, the metal foil layer made of the metal foil pressurized and attached onto either one or both of the two base plates on the surface facing the other base plate extends together with the adhesive layer made of the adhesive for attaching the metal foil layer from the position more radially inward than the annular bead to the position radially outward so as to overlap each of the annular beads of the base plate and to face the top portion of the annular bead, and thereby constitutes a step structure by annularly surrounding the respective cylinder holes on the base plates. Therefore, line pressure to be applied to the top portions of the annular beads on the two base plates is increased even in the case of the metal gasket including the two sheets, and it is possible to exert a high sealing performance against combustion gas pressure inside the cylinder bores. Moreover, according to this metal gasket, the adhesive constituting the adhesive layer attaches the metal foil layer to the auxiliary plate while at least being pressurized. Therefore, it is possible to form the step structure in a desired thickness easily either by pressing and allowing the adhesive layer to flow under the metal foil or by extruding part of the adhesive from under the metal foil, and to obtain an amount of the step easily for optimizing balance of constriction forces between the annular bead and the outer peripheral bead.

The metal foil layer in this invention is preferably made of any of aluminum, an aluminum alloy, steel, stainless steel, bronze, titanium, and nickel, and preferably has the hardness equal to or above Hv 60, because such a metal foil has high heat resistance, and is break-proof and able to maintain the shape easily. Accordingly, it is easy to handle the metal foil at the time of formation and attachment.

Meanwhile, the adhesive for the adhesive layer in this invention is preferably made of any of phenol, epoxy, and polyimide, or a combination of at least two types of these materials, because such an adhesive has high heat resistance.

An object of a metal gasket for a cylinder head according to a third aspect of this invention is to provide a metal gasket capable of solving the foregoing problems advantageously, which has a high sealing property and excellent heat resistance. The metal gasket of this third aspect includes at least two base plates respectively made of metal plates and laminated on each other, each of which includes cylinder holes formed so as to correspond to respective cylinder bores on a cylinder block of an internal combustion engine, annular beads of an angled cross-sectional shape formed around the respective cylinder holes, coolant holes formed on outer peripheral portions of the respective annular beads so as to correspond to coolant jackets on the cylinder block and to coolant holes on a cylinder head of the internal combustion engine, and an outer peripheral bead having a cross-sectional shape sloping on one side and being formed in a position so as to totally surround the annular beads and the coolant holes. The metal gasket also includes soft surface metal-plated layers formed on at least outer surfaces of the two base plates so as to cover at least the respective annular beads.

Meanwhile, a metal gasket of this invention includes a single base plate made of a metal plate, which includes cylinder holes formed so as to correspond to respective cylinder bores on a cylinder block of an internal combustion engine, annular beads of an angled cross-sectional shape formed around the respective cylinder holes, coolant holes formed on outer peripheral portions of the respective annular beads so as to correspond to coolant jackets on the cylinder block and to coolant holes on a cylinder head of the internal combustion engine, and an outer peripheral bead having a cross-sectional shape sloping on one side and being formed in a position so as to totally surround the annular beads and the coolant holes. The metal gasket also includes soft surface metal-plated layers formed on both surfaces of the base plate so as to cover at least the respective annular beads.

According to these metal gaskets for a cylinder head, the soft surface metal-plated layers formed on the outer surfaces of the single or two base plates (on the both surfaces in the case of the single sheet) so as to cover at least the respective annular beads serve as surface sealing layers to perform a function as micro sealing by burying small scratches and processing scars on deck surfaces of the cylinder block and the cylinder head. Therefore, it is possible to exert a high sealing property. Moreover, according to these metal gaskets, the soft surface metal-plated layer is made of metal. Therefore, it is possible to exert high heat resistance at the annular beads around the cylinder holes exposed to high heat in particular.

Here, in the metal gasket of this invention, as described in claim 3, the soft surface metal-plated layer is preferably formed as a single layer or a plurality of layers using any of tin, copper, silver, and alloys thereof, and preferably has the surface hardness equal to or below Hv 60. When the surface hardness is low, it is easier to bury small scratches and processing scars on the deck surfaces.

Meanwhile, in this invention, the thickness of the soft surface metal-plated layer is preferably set in a range from 3 μm to 40 μm inclusive, because it is not possible to sufficiently bury small scratches and processing scars on the deck surfaces if the thickness is below 3 μm, and the sealing property will not be improved very much if the thickness exceeds 40 μm.

### BRIEF DESCRIPTION O THE DRAWINGS

FIG. 1 is a plan view showing the entirety of Example 1 of a metal gasket for a cylinder head in a first aspect of this invention.

FIG. 2 is a cross-sectional view of the metal gasket of the above-described Example 1, which is taken along the A-A line in FIG. 1.

FIGS. 3(a) and 3(b) are explanatory views showing a method of providing a hard metal-plated layer on an auxiliary plate of the metal gasket of the above-described Example 1.

FIG. 4 is a cross-sectional view of a metal gasket for a cylinder head according to Example 5 of this invention in a similar position to FIG. 1.

FIG. 5 is a cross-sectional view of a metal gasket for a cylinder head according to Example 38 of this invention in a similar position to FIG. 1.

FIG. 6 is a cross-sectional view of a metal gasket for a cylinder head according to Example 39 of this invention in a similar position to FIG. 1.

FIG. 7 is a cross-sectional view of a metal gasket for a cylinder head according to Example 40 of this invention in a similar position to FIG. 1.

FIG. 8 is a cross-sectional view of a metal gasket for a cylinder head according to Example 41 of this invention in a similar position to FIG. 1.

FIG. 9 is an explanatory view showing a measuring method for sealing limit pressure of metal gaskets 1 according to the above-described examples and comparative examples.

FIGS. 10(a) to 10(d) are explanatory views respectively showing sealing performances in terms of a comparative example without a step structure and examples of this invention.

FIGS. 11(a) to 11(c) are explanatory views respectively showing sealing performances in terms of the comparative example without the step structure, a comparative example with a metal plated layer of a different material, and the example of this invention.

FIGS. 12(a) to 12(d) are explanatory views respectively showing sealing performances in terms of the comparative example setting constant amounts of steps and examples of this invention.

FIGS. 13(a) to 13(d) are explanatory views respectively showing sealing performances in terms of another comparative example setting constant amounts of steps and examples of this invention.

FIG. 14 is a cross-sectional view of a metal gasket according to Example 1 of a second aspect of this invention, which is taken along the A-A line in FIG. 1.

FIGS. 15(a) to 15(c) are explanatory views showing a method of providing a resin layer on an auxiliary plate of the metal gasket of the above-described Example 1.

FIG. 16 is a cross-sectional view of a metal gasket for a cylinder head according to Example 2 of this invention in a similar position to FIG. 1.

FIG. 17 is a cross-sectional view of a metal gasket for a cylinder head according to Example 9 of this invention in a similar position to FIG. 1.

FIG. 18 is a cross-sectional view of a metal gasket for a cylinder head according to Example 10 of this invention in a similar position to FIG. 1.

FIG. 19 is an explanatory view showing comparison of sealing performances after thermal degradation among the example of this invention and comparative examples having metal foil layers made of different materials.

FIGS. 20(a) and 20(b) are cross-sectional views of a base plate taken along the A-A line and the B-B line in FIG. 1.

FIG. 21 is an enlarged cross-sectional view showing a base plate and soft surface metal-plated layers of a metal gasket according to an example of a third aspect of this invention.

FIG. 22 is an enlarged cross-sectional view showing a base plate and soft surface metal-plated layers of a metal gasket for a cylinder head according to another example of this invention.

FIGS. 23(a) and 23(b) are a plan view and a half cross-sectional view showing a shape and dimensions of a gasket test piece.

FIG. 24 is a cross-sectional view showing an outline of a sealing test apparatus.

FIG. 25 is an explanatory view showing results of performing the above-described sealing test in terms of specimens 1 to 3 and Comparative Example 1 shown in Table 3-1.

FIG. 26 is an explanatory view showing results of performing the above-described sealing test in terms of specimens 1 to 8 and Comparative Example 1 shown in Table 3-2.

FIG. 27 is a cross-sectional view showing an outline of a thermal degradation test apparatus.

FIG. 28 is an explanatory view showing results of performing the thermal degradation test and the sealing test in terms of specimens 1 and 2 and Comparative Examples 1 and 2 shown in Table 3-3.

FIG. 29 is a cross-sectional view showing an example of a step structure of a conventional metal gasket for a cylinder head in a similar position to FIG. 1.

FIG. 30 is a cross-sectional view showing another example of a step structure of a conventional metal gasket for a cylinder head in a similar position to FIG. 1.

FIG. 31 is a cross-sectional view showing still another example of a step structure of a conventional metal gasket for a cylinder head in a similar position to FIG. 1.

FIG. 32 is a cross-sectional view showing an example of a surface sealing layer of a conventional metal gasket for a cylinder head.

FIG. 33 is a cross-sectional view showing another example of a surface sealing layer of a conventional metal gasket for a cylinder head.

### BEST MODES FOR CARRYING OUT THE INVENTION

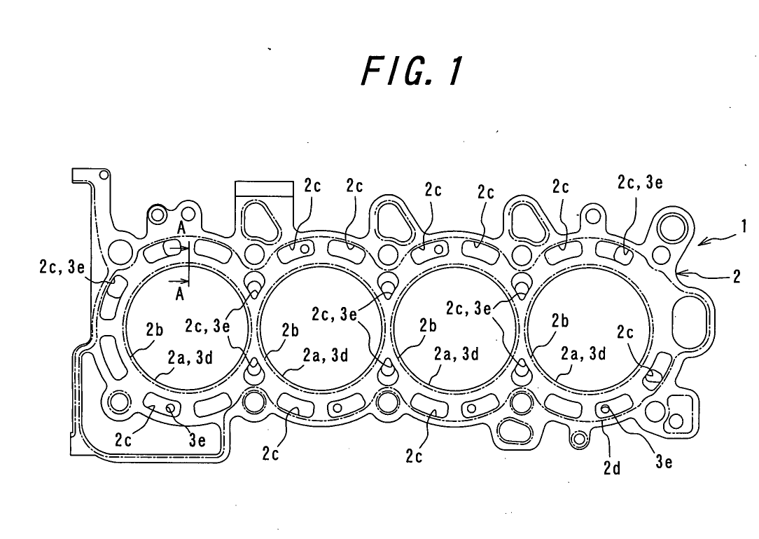

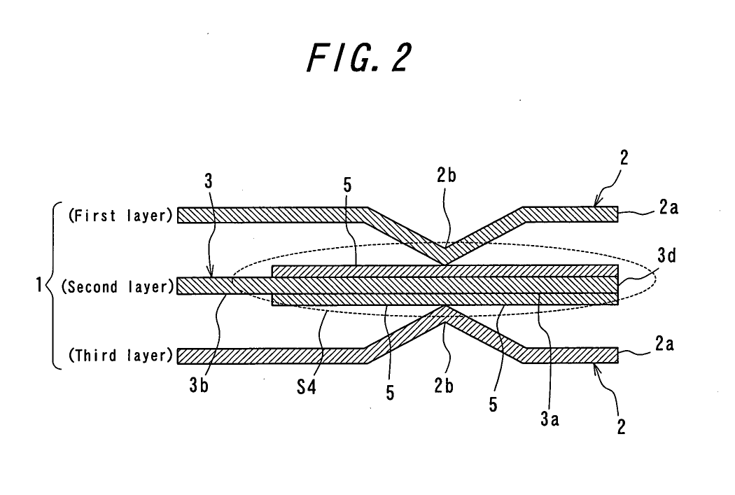

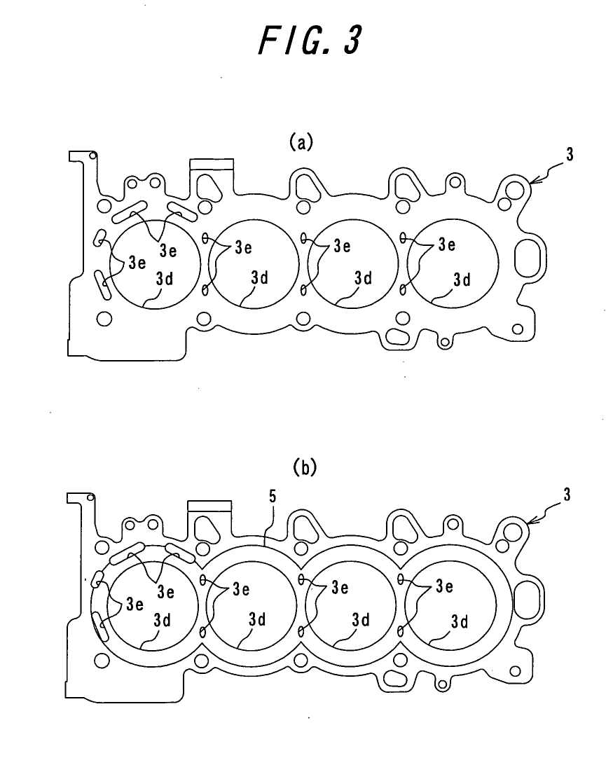

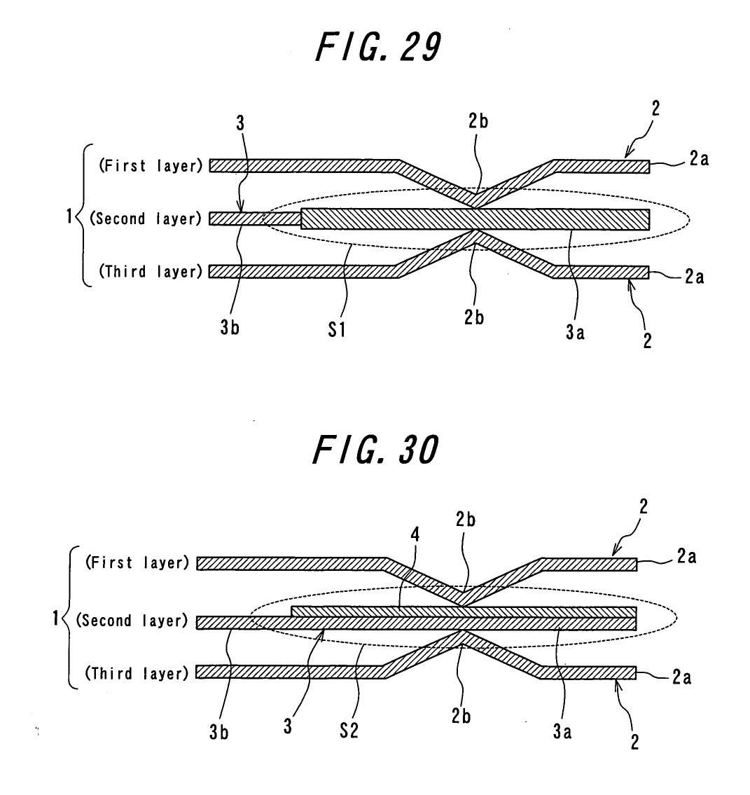

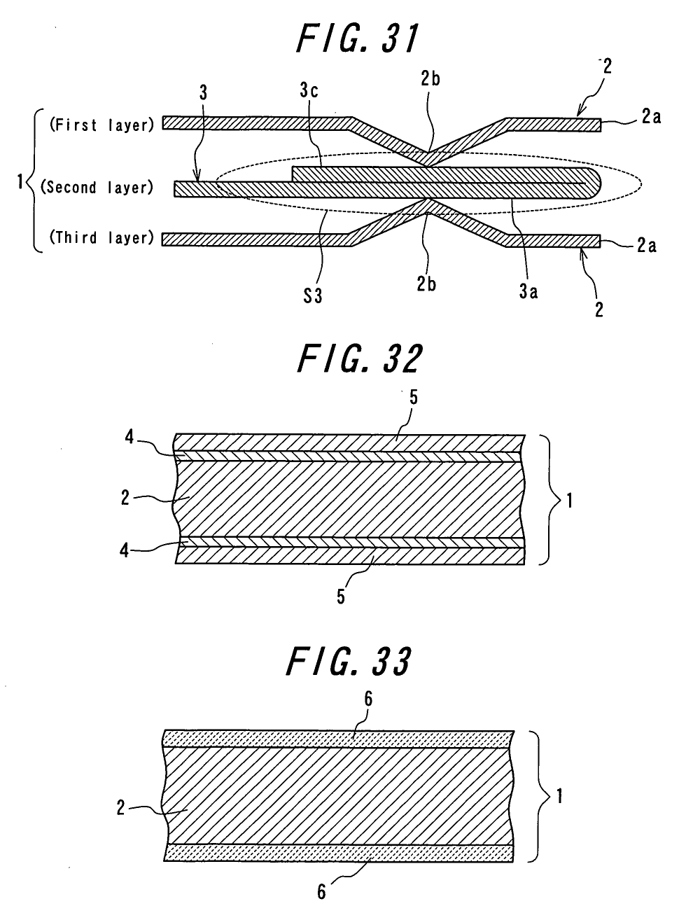

An embodiment according to a first aspect of this invention will be described below by use of examples and based on the accompanying drawings. Here, FIG. 1 is a plan view showing the entirety of Example 1 of a metal gasket for a cylinder head of this invention. FIG. 2 is a cross-sectional view taken along the A-A line in FIG. 1. FIGS. 3(a) and 3(b) are explanatory views showing a method of providing a hard metal-plated layer on an auxiliary plate of the metal gasket of the above-described Example 1. In these drawings, similar portions to those shown in FIG. 29 to FIG. 31 described above are indicated with the same reference numerals. Specifically, reference numeral 1 denotes a metal gasket, reference numeral 2 denotes a base plate, and reference numeral 3 denotes an auxiliary plate, respectively.

The metal gasket 1 for a cylinder head of the above-described Example 1 includes two base plates 2 layered over each other, which are made of a steel plate (SUS 301H 0.2t) subjected to rubber coating of a rubber layer made of NBR in the thickness of 25 μm only onto respective outer side surfaces (surfaces facing a cylinder block and a cylinder head), and an auxiliary plate 3 made of a steel plate (SUS 301H 0.2t) without rubber coating which is to be interposed between the base plates 2.

As shown in FIG. 1, each of the two base plates 2 herein includes four cylinder holes 2a formed so as to correspond respectively to four cylinder bores on the cylinder block of an internal combustion engine (the cylinder holes 2a correspond sequentially to the cylinder bores #1, #2, #3, and #4 from the left in FIG. 1), annular beads 2b of an angled cross-sectional shape (so-called a full bead shape) formed around the respective cylinder holes 2a, a plurality of coolant holes 2c formed at outer peripheral portions of the respective annular beads 2b so as to correspond to coolant jackets on the cylinder block and to coolant holes on the cylinder head of the above-described internal combustion engine, and an outer peripheral bead 2d of a cross-sectional shape sloping on one side (so called a half bead shape) which is formed in a position so as to totally surround the plurality of annular beads 2b and the plurality of coolant holes 2c located in the peripheries thereof.

Moreover, as shown in FIG. 3(a), the auxiliary plate 3 herein includes cylinder holes 3d corresponding to the respective cylinder holes 2a on the base plates 2, and coolant holes 3e corresponding to some of the coolant holes 2c on the above-described base plates 2.

As shown in FIG. 2, the metal gasket 1 for a cylinder head of this Example 1 further includes hard metal-plated layers 5 on both surfaces of the auxiliary plate 3 in the total thickness for the both surfaces in a range from 49 to 51 μm (see Table 1-1 for more detail). As shown in FIG. 3(b), these hard metal-plated layers 5 are made of nickel (the hardness equal to Hv 255) formed on peripheral portions of the respective cylinder holes 3d on the both surfaces of the auxiliary plate 3 in accordance with an electroplating process or a molten metal plating process, for example. When the hard metal-plated layers 5 are interposed between the two base plates 2 together with the auxiliary plate 3, the hard metal-plated layers 5 extend from positions more radially inward than the annular beads 2b to positions radially outward so as to overlap the respective annular beads 2b of the base plates 2 and to face top portions of the annular beads 2b, and thereby annularly surround the respective cylinder holes 3d on the auxiliary plate 3 and eventually the respective cylinder holes 2a on the base plates 2 corresponding thereto.

According to the metal gasket 1 of the above-described Example 1, the hard metal-plated layers 5 formed on the both surfaces of the auxiliary plate 3 to be interposed between the two base plates 2 extend from the positions more radially inward than the annular beads 2b to the positions radially outward so as to overlap the respective annular beads 2b of the base plates 2 and to face the top portions of the annular beads 2b, and surround the respective cylinder holes 2a on the base plates 2 annularly to constitute a step structure S4 having an amount of the step approximately equal to 50 μm. Therefore, line pressure to be applied to the top portions of the annular beads 2b of the two base plates 2 is increased, and it is possible to exert a high sealing performance against combustion gas pressure inside the cylinder bores as will be described later.

Moreover, according to the metal gasket 1 of this Example 1, the hard metal-plated layer 5 is made of nickel. Therefore, it is possible to maintain the high sealing performance as the step structure for the annular beads 2b around the cylinder holes 2a exposed to high heat in particular. Meanwhile, since the hard metal-plated layer 5 is formed in accordance with a plating process, it is also easy to adjust the layer thickness thereof. In this way, it is possible to obtain an amount of the step easily for optimizing balance of constriction forces between the annular bead 2b and the outer peripheral bead 2d.

In addition, according to the metal gasket 1 of this Example 1, the outer surfaces of the respective steel plates in the two base plates 2 are subjected to rubber coating to be covered with the rubber layers. Therefore, it is possible to improve the sealing performance as the rubber layers perform a function as micro sealing by burying small scratches and processing scars on deck surfaces of the cylinder block and the cylinder head.

Here, one which applies a similar configuration to Example 1 including the nickel hard metal-plated layers 5 on the both surfaces of the flat auxiliary plate 3 except that the total thicknesses (the amounts of the steps) of the hard metal-plated layers 5 are set uniformly equal to 80 μm in terms of the four cylinder holes 2a will be defined as Example 2 of the metal gasket for a cylinder head of this invention. According to this Example 2, the amount of the step is greater than Example 1. Therefore, it is possible to exert a higher sealing performance than Example 1 as will be described later.

Moreover, one which applies a similar configuration to Example 1 including the nickel hard metal-plated layers 5 on the both surfaces of the flat auxiliary plate 3 except that the total thicknesses (the amounts of the steps) of the hard metal-plated layers 5 are set respectively equal to 49 μm, 81 μm, 79 μm, and 50 μm from the left in FIG. 1 in terms of the four cylinder holes 2a, so as to correspond to the case where rigidity distribution of the internal combustion engine concerning the four cylinder bores of the internal combustion engine is lower in #2 and #3 than in #1 and #4, will be defined as Example 3 of the metal gasket for a cylinder head of this invention. In addition, one which applies a similar configuration to Example 1 including the nickel hard metal-plated layers 5 on the both surfaces of the flat auxiliary plate 3 except that the total thicknesses (the amounts of the steps) of the hard metal-plated layers 5 are set respectively equal to 47 μm, 105 μm, 103 μm, and 50 μm from the left in FIG. 1 in terms of the four cylinder holes 2a, so as to correspond to the case where the rigidity distribution of the internal combustion engine concerning the four cylinder bores of the internal combustion engine is lower in #2 and #3 than in #1 and #4, will be defined as Example 4 of the metal gasket for a cylinder head of this invention. According to these Examples 3 and 4, the amounts of the steps correspond to the rigidity distribution of the internal combustion engine. Therefore, it is possible to exert higher sealing performances than the foregoing examples as will be described later.

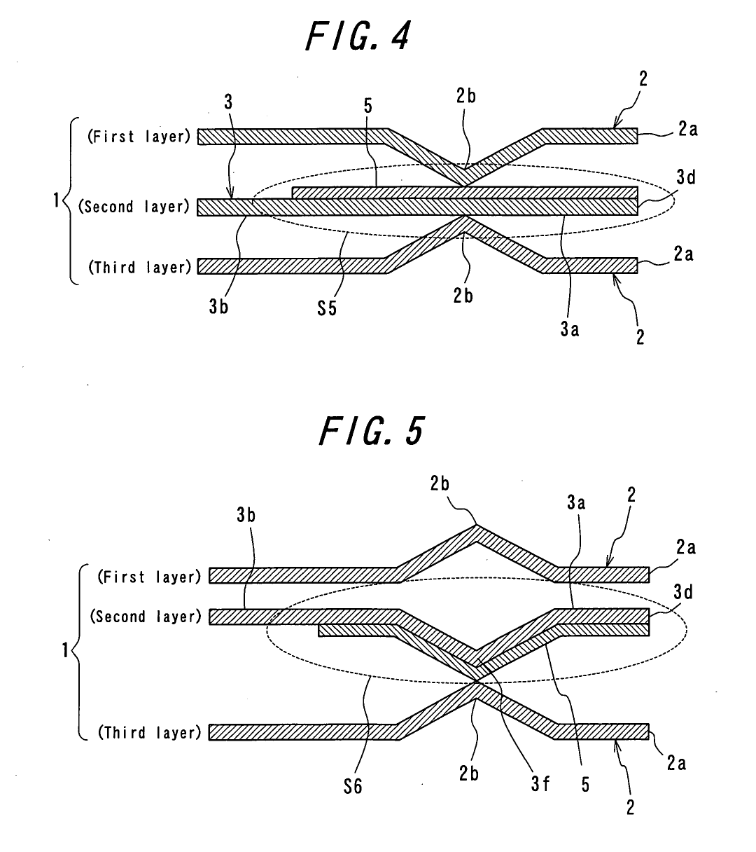

FIG. 4 is a cross-sectional view of the metal gasket for a cylinder head according to Example 5 of this invention in a similar position to FIG. 1. The metal gasket 1 of this Example 2 is only different from the foregoing Example 1 in that the hard metal-plated layer 5 is provided on one surface (which is an upper surface in the drawing) of the auxiliary plate 3 in the thickness from 49 to 51 μm (see Table 1-1 for more detail), which is made of nickel (the hardness equal to Hv 255) and formed by an electroplating process or a molten metal plating process, for example, to constitute a step structure S5 having an amount of the step approximately equal to 50 μm. Other features are identical to those in Example 1. According to this Example 5, it is also possible to obtain similar operations and effects to those in the forgoing Example 1.

Here, ones which apply a similar configuration to Example 5 including the nickel hard metal-plated layer 5 on one of the surfaces of the flat auxiliary plate 3 except that the thicknesses (the amounts of the steps) of the hard metal-plated layer 5 are set uniformly equal to 80 μm and 100 μm respectively in terms of the four cylinder holes 2a will be defined as Example 6 and Example 7 of the metal gaskets for a cylinder head of this invention. According to these Examples 6 and 7, the amounts of the steps are greater than Example 5. Therefore, it is possible to exert higher sealing performances than Example 5 as will be described later.

Moreover, one which applies a similar configuration to Example 5 including the nickel hard metal-plated layer 5 on one of the surfaces of the flat auxiliary plate 3 except that the thicknesses (the amounts of the steps) of the hard metal-plated layer 5 are set respectively equal to 50 μm, 82 μm, 83 μm, and 49 μm from the left in FIG. 1 in terms of the four cylinder holes 2a, so as to correspond to the case where the rigidity distribution of the internal combustion engine concerning the four cylinder bores of the internal combustion engine is lower in #2 and #3 than in #1 and #4, will be defined as Example 8 of the metal gasket for a cylinder head of this invention. In addition, one which applies a similar configuration to Example 5 including the nickel hard metal-plated layer 5 on one of the surfaces of the flat auxiliary plate 3 except that the thicknesses (the amounts of the steps) of the hard metal-plated layer 5 are set respectively equal to 47 μm, 105 μm, 103 μm, and 50 μm from the left in FIG. 1 in terms of the four cylinder holes 2a, so as to correspond to the case where the rigidity distribution of the internal combustion engine concerning the four cylinder bores of the internal combustion engine is lower in #2 and #3 than in #1 and #4, will be defined as Example 9 of the metal gasket for a cylinder head of this invention. According to these Examples 8 and 9, the amounts of the steps correspond to the rigidity distribution of the internal combustion engine. Therefore, it is possible to exert higher sealing performances than the foregoing examples as will be described later.

Meanwhile, one which applies a similar configuration to Example 1 including the nickel hard metal-plated layers 5 on the both surfaces of the flat auxiliary plate 3 except that the total thicknesses (the amounts of the steps) of the hard metal-plated layers 5 are set respectively equal to 82 μm, 49 μm, 51 μm, and 80 μm from the left in FIG. 1 in terms of the four cylinder holes 2a, so as to correspond to the case where rigidity distribution of the internal combustion engine concerning the four cylinder bores of the internal combustion engine is lower in #1 and #4 than in #2 and #3, will be defined as Example 10 of the metal gasket for a cylinder head of this invention. In addition, one which applies a similar configuration to Example 1 including the nickel hard metal-plated layers 5 on the both surfaces of the flat auxiliary plate 3 except that the total thicknesses (the amounts of the steps) of the hard metal-plated layers 5 are set respectively equal to 100 μm, 50 μm, 50 μm, and 100 μm from the left in FIG. 1 in terms of the four cylinder holes 2a, so as to correspond to the case where the rigidity distribution of the internal combustion engine concerning the four cylinder bores of the internal combustion engine is lower in #1 and #4 than in #2 and #3, will be defined as Example 11 of the metal gasket for a cylinder head of this invention. According to these Examples 10 and 11, the amounts of the steps correspond to the rigidity distribution of the internal combustion engine. Therefore, it is possible to exert higher sealing performances than the foregoing examples as will be described later.

Moreover, one which applies a similar configuration to Example 5 including the nickel hard metal-plated layer 5 on one of the surfaces of the flat auxiliary plate 3 except that the thicknesses (the amounts of the steps) of the hard metal-plated layer 5 are set respectively equal to 81 μm, 48 μm, 50 μm, and 81 μm from the left in FIG. 1 in terms of the four cylinder holes 2a, so as to correspond to the case where the rigidity distribution of the internal combustion engine concerning the four cylinder bores of the internal combustion engine is lower in #1 and #4 than in #2 and #3, will be defined as Example 12 of the metal gasket for a cylinder head of this invention. In addition, one which applies a similar configuration to Example 5 including the nickel hard metal-plated layer 5 on one of the surfaces of the flat auxiliary plate 3 except that the thicknesses (the amounts of the steps) of the hard metal-plated layer 5 are set respectively equal to 103 μm, 49 μm, 49 μm, and 102 μm from the left in FIG. 1 in terms of the four cylinder holes 2a, so as to correspond to the case where the rigidity distribution of the internal combustion engine concerning the four cylinder bores of the internal combustion engine is lower in #1 and #4 than in #2 and #3, will be defined as Example 13 of the metal gasket for a cylinder head of this invention. According to these Examples 12 and 13, the amounts of the steps correspond to the rigidity distribution of the internal combustion engine. Therefore, it is possible to exert higher sealing performances than the foregoing examples as will be described later.

Furthermore, ones applying similar configurations to the above-described Examples 1 to 6 and Examples 8 to 13 except that the hard metal-plated layers 5 are made of nickel-phosphorus (Hv 868) will be herein defined as Examples 14 to 25. Meanwhile, ones applying similar configurations to the above-described Examples 1 to 6 and Examples 8 to 13 except that the hard metal-plated layers 5 are made of copper (Hv 95) will be defined as Examples 26 to 37.

FIG. 5 is a cross-sectional view of a metal gasket for a cylinder head according to Example 38 of this invention in a similar position to FIG. 1. This metal gasket 1 of Example 38 is only different from the foregoing Example 8 in that an annular bead 3f of an angled cross-sectional shape is formed on the auxiliary plate 3 so as to overlap the annular beads 2b of the base plates 2 and to allow a top position to face a top position of the annular bead 2b of the base plate 2 on the lower side, and that the hard metal-plated layer 5 is provided on one surface (on the protruding side of the annular bead 3f) of the auxiliary plate 3 in the thickness from 49 to 81 μm (see Table 1-1 for more detail) corresponding to the rigidity distribution of the internal combustion engine, which is made of nickel (the hardness equal to Hv 255) and formed by an electroplating process or a molten metal plating process, for example, to constitute a step structure S6. Other features are identical to those in Example 8. According to this Example 38, the annular beads 2b and 3f are stacked in three layers, and it is possible to obtain a higher sealing performance than the foregoing Example 8 as will be described later.

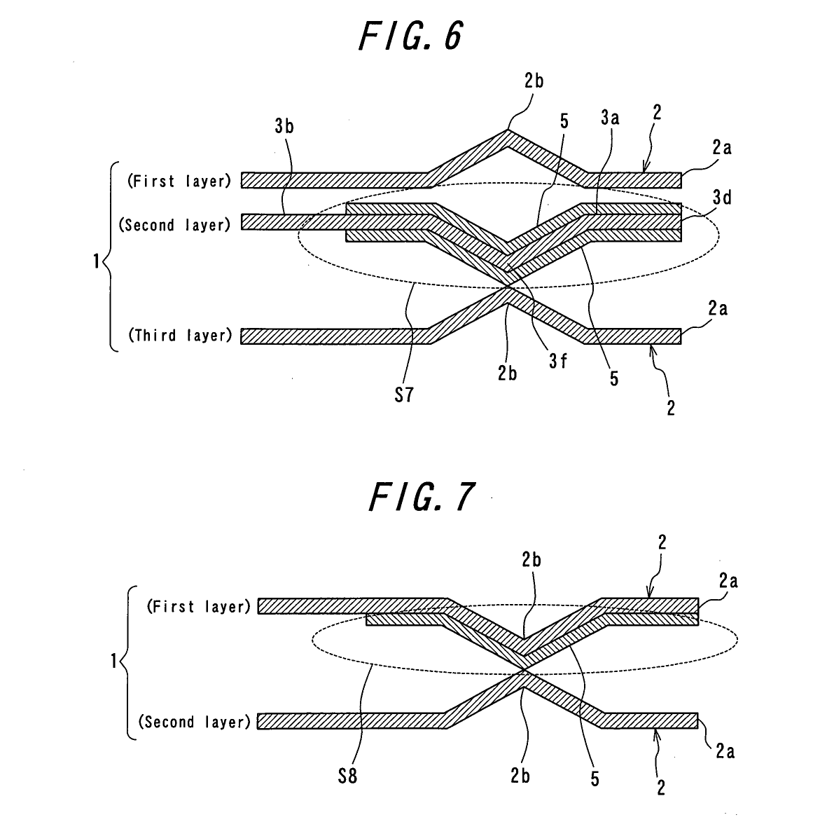

FIG. 6 is a cross-sectional view of a metal gasket for a cylinder head according to Example 39 of this invention in a similar position to FIG. 1. This metal gasket 1 of Example 39 is only different from the foregoing Example 3 in that an annular bead 3f of an angled cross-sectional shape is formed on the auxiliary plate 3 so as to overlap the annular beads 2b of the base plates 2 and to allow a top position to face a top position of the annular bead 2b of the base plate 2 on the lower side, and that the hard metal-plated layers 5 are provided on both surfaces of the auxiliary plate 3 in the total thickness from 47 to 83 μm (see Table 1-1 for more detail) corresponding to the rigidity distribution of the internal combustion engine, which are made of nickel (the hardness equal to Hv 255) and formed by an electroplating process or a molten metal plating process, for example, to constitute a step structure S7. Other features are identical to those in Example 3. According to this Example 39, the annular beads 2b and 3f are stacked in three layers, and it is possible to obtain a higher sealing performance than the foregoing Example 3 as will be described later.

FIG. 7 is a cross-sectional view of a metal gasket for a cylinder head according to Example 40 of this invention in a similar position to FIG. 1. This metal gasket 1 of Example 40 does not include the auxiliary plate 3 between the two base plates 2. However, the respective base plates 2 are similar to those in the foregoing examples. Moreover, in this example, the hard metal-plated layer 5 is provided on one of the base plates 2 (which is located on the upper side in the drawing) on a surface (an inner side surface) facing the other base plate (which is the base plate on the lower side in the drawing) 2 in the thickness from 49 to 82 μm (see Table 1-1 for more detail) corresponding to the rigidity distribution of the internal combustion engine. This hard metal-plated layer 5 is made of nickel (the hardness equal to Hv 255) and formed at a peripheral portion of each of the cylinder holes 2a of the base plate 2 by an electroplating process or a molten metal plating process. When the two base plates 2 are layered over each other, the hard metal-plated layer 5 extends from a position more radially inward than the annular bead 2b to a position radially outward so as to overlap each of the annular beads 2b of the other base plate 2 and to face a top portion of the annular bead 2b, and thereby surrounds each of the cylinder holes 2a on the base plate 2 annularly to constitute a step structure S8.

According to the metal gasket 1 of the above-described Example 40, it is possible to manufacture the gasket at low costs because there is no auxiliary plate 3. Moreover, it is also possible to obtain a substantially equivalent sealing performance to the foregoing Example 1 as will be described later.

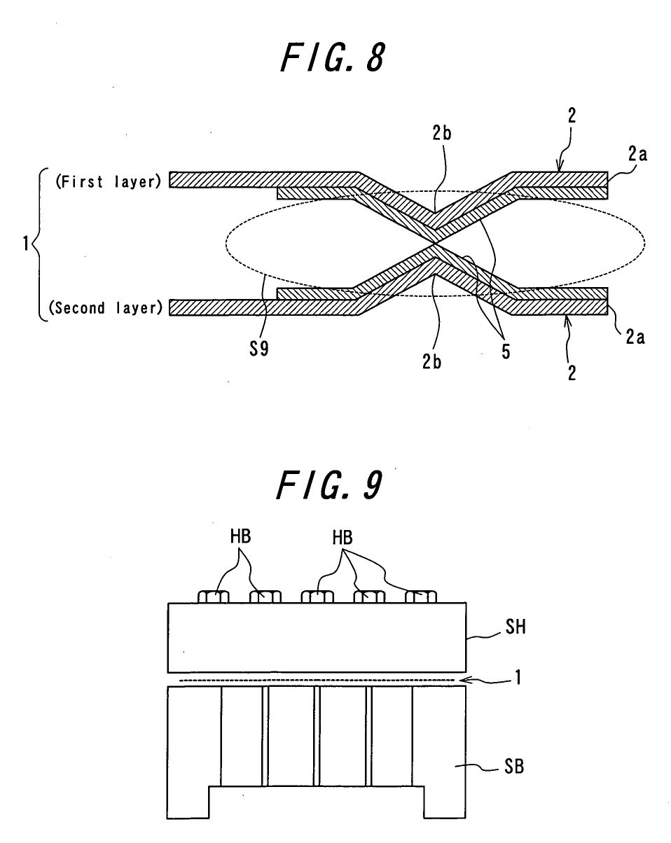

FIG. 8 is a cross-sectional view of a metal gasket for a cylinder head according to Example 41 of this invention in a similar position to FIG. 1. This metal gasket 1 of Example 41 does not include the auxiliary plate 3 between the two base plates 2. However, the respective base plates 2 are similar to those in the foregoing examples. Moreover, in this example, the hard metal-plated layers 5 are provided on the both base plates 2 on surfaces (inner side surfaces) mutually facing the opponent base plates 2 in the total thickness from 51 to 82 μm (see Table 1-1 for more detail) corresponding to the rigidity distribution of the internal combustion engine. These hard metal-plated layers 5 are made of nickel (the hardness equal to Hv 255) and formed at a peripheral portion of each of the cylinder holes 2a of the base plate 2 by an electroplating process or a molten metal plating process. When the two base plates 2 are layered over each other, the hard metal-plated layer 5 extends from a position more radially inward than the annular bead 2b to a position radially outward so as to overlap each of the annular beads 2b of the opponent base plate 2 and to face a top portion of the annular bead 2b, and thereby surrounds each of the cylinder holes 2a on the base plate 2 annularly to constitute a step structure S9.

According to the metal gasket 1 of the above-described Example 41, it is possible to manufacture the gasket at low costs because there is no auxiliary plate 3. Moreover, it is also possible to obtain a substantially equivalent sealing performance to the foregoing Example 3 as will be described later.

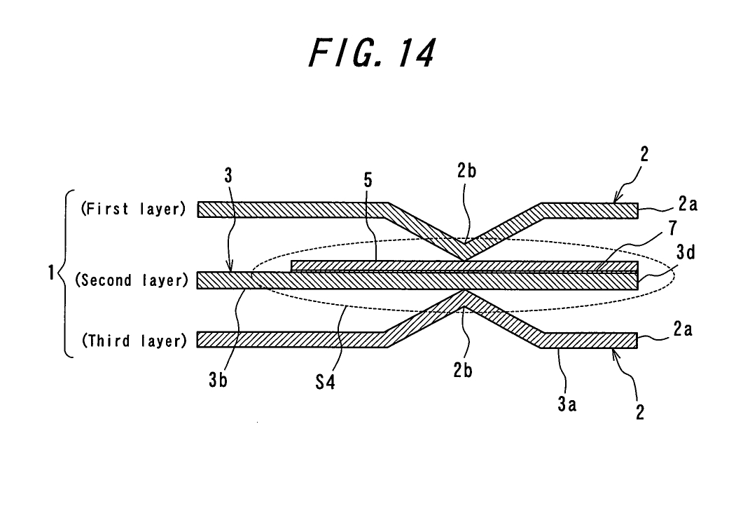

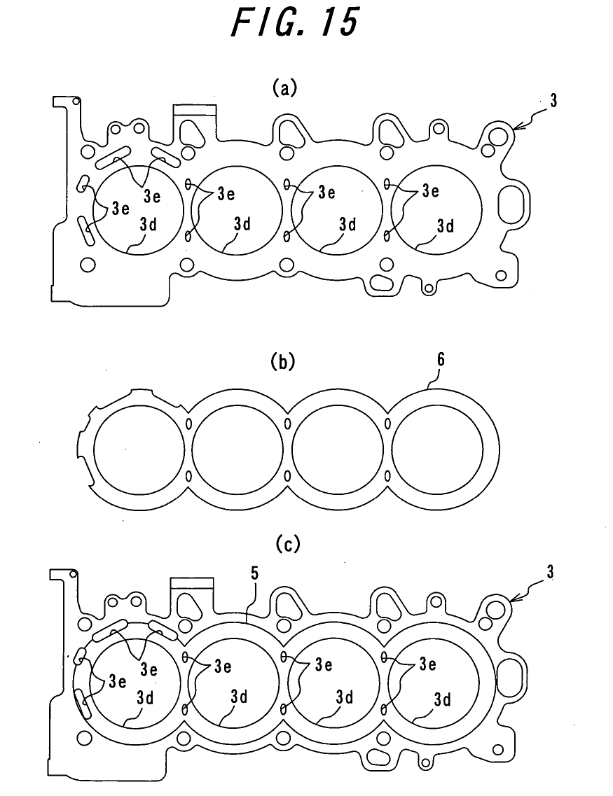

The following Table 1-1 to Table 1-5 show comparison of the configurations and the sealing performances among the metal gaskets of the above-described Example 1 to Example 41, a metal gasket of Comparative Example 1 configured to remove the hard metal-plated layers 5 from Example 1, a metal gasket of Comparative Example 2 configured to obtain the same amount of the step as Example 1 by means of butt joint, a metal gasket of Comparative Example 3 provided with soft surface metal-plated layers made of tin (Hv 15) instead of the hard metal-plated layers 5 in Example 1, a metal gasket of Comparative Example 4 configured to obtain constant amounts of steps approximately equal to 50 μm in a similar configuration to Example 38 by means of butt joint shown in FIG. 14, and a metal gasket of Comparative Example 4 configured to obtain constant amounts of steps approximately equal to 50 μm in a similar configuration to Example 40 by means of the butt joint shown in FIG. 14. Concerning the sealing limit pressure herein, as shown in FIG. 9, each of the metal gaskets 1 described above is placed between a cylinder block SB and a cylinder head SH, and head bolts HB are tightened at a prescribed axial force (34.4 kN/bolt) to form a specimen by subjecting a piston inside the cylinder bore and a valve in a combustion chamber to a hermetic sealing process. The sealing limit pressure on the tables represents a result of measurement of sealing limit pressure of the specimen by injecting air from an ignition plug hole into the cylinder bore in a room-temperature atmosphere and then increasing pressure inside the cylinder bore.

From these Table 1-1 to Table 1-5, it is apparent that the sealing performances of the metal gaskets of the respective examples described above are considerably higher than those of Comparative Examples adopting similar bead structures

TABLE 1-1

| | | Hard metal-plated layer | | | | | | | | Sealing |
|---|---|---|---|---|---|---|---|---|---|---|
| | | | | Amounts of steps | | | | Number | | limit |
| | | | Attached | μm | | | | of metal | Bead | pressure |
| | | Material | surfaces | #1 | #2 | #3 | #4 | plates | structure | MPa |
| Examples | 1 | nickel | both | 50 | 51 | 50 | 49 | 3 | 3S2B | 8.0 |
| | | | surfaces | | | | | | | |
| | 2 | ″ | both | 80 | 80 | 80 | 80 | 3 | 3S2B | 9.0 |
| | | | surfaces | | | | | | | |
| | 3 | ″ | both | 49 | 81 | 79 | 50 | 3 | 3S2B | 9.9 |
| | | | surfaces | | | | | | | |
| | 4 | ″ | both | 47 | 105 | 103 | 50 | 3 | 3S2B | 10.8 |
| | | | surfaces | | | | | | | |
| | 5 | ″ | one | 50 | 51 | 50 | 49 | 3 | 3S2B | 8.0 |
| | | | surface | | | | | | | |
| | 6 | ″ | one | 80 | 80 | 80 | 80 | 3 | 3S2B | 9.1 |
| | | | surface | | | | | | | |
| | 7 | ″ | one | 100 | 100 | 100 | 100 | 3 | 3S2B | 10.9 |
| | | | surface | | | | | | | |
| | 8 | ″ | one | 50 | 82 | 83 | 49 | 3 | 3S2B | 9.9 |
| | | | surface | | | | | | | |
| | 9 | ″ | one | 47 | 105 | 103 | 50 | 3 | 3S2B | 10.8 |
| | | | surface | | | | | | | |
| | 10 | ″ | both | 82 | 49 | 51 | 80 | 3 | 3S2B | 9.8 |
| | | | surfaces | | | | | | | |
| | 11 | ″ | both | 100 | 50 | 50 | 100 | 3 | 3S2B | 10.9 |
| | | | surfaces | | | | | | | |

TABLE 1-2

| | | Hard metal-plated layer | | | | | | | | sealing |
|---|---|---|---|---|---|---|---|---|---|---|
| | | | | Amounts of steps | | | | Number | | limit |
| | | | Attached | μm | | | | of metal | Bead | pressure |
| | | Material | surfaces | #1 | #2 | #3 | #4 | plates | structure | MPa |
| Examples | 12 | nickel | one | 81 | 48 | 50 | 81 | 3 | 3S2B | 9.8 |
| | | | surface | | | | | | | |
| | 13 | ″ | one | 103 | 49 | 49 | 102 | 3 | 3S2B | 10.8 |
| | | | surface | | | | | | | |
| | 14 | nickel- | both | 48 | 49 | 49 | 50 | 3 | 3S2B | 7.8 |
| | | phosphorus | surfaces | | | | | | | |
| | 15 | nickel- | both | 79 | 81 | 80 | 82 | 3 | 3S2B | 8.9 |
| | | phosphorus | surfaces | | | | | | | |
| | 16 | nickel- | both | 48 | 81 | 79 | 52 | 3 | 3S2B | 10.0 |
| | | phosphorus | surfaces | | | | | | | |
| | 17 | nickel- | both | 47 | 102 | 101 | 49 | 3 | 3S2B | 11.0 |
| | | phosphorus | surfaces | | | | | | | |
| | 18 | nickel- | one | 48 | 49 | 51 | 53 | 3 | 3S2B | 8.2 |
| | | phosphorus | surface | | | | | | | |
| | 19 | nickel- | one | 79 | 81 | 82 | 79 | 3 | 3S2B | 9.0 |
| | | phosphorus | surface | | | | | | | |
| | 20 | nickel- | one | 48 | 77 | 79 | 49 | 3 | 3S2B | 10.1 |
| | | phosphorus | surface | | | | | | | |
| | 21 | nickel- | one | 49 | 101 | 102 | 49 | 3 | 3S2B | 11.0 |
| | | phosphorus | surface | | | | | | | |

TABLE 1-3

| | | Hard meal-plated layer | | | | | | | | sealing |
|---|---|---|---|---|---|---|---|---|---|---|
| | | | | Amounts of steps | | | | Number | | limit |
| | | | Attached | μm | | | | of metal | Bead | pressure |
| | | Material | surfaces | #1 | #2 | #3 | #4 | plates | structure | MPa |
| Examples | 22 | nickel- | both | 79 | 48 | 49 | 79 | 3 | 3S2B | 9.9 |
| | | phosphorus | surfaces | | | | | | | |
| | 23 | nickel- | both | 99 | 49 | 51 | 49 | 3 | 3S2B | 11.0 |
| | | phosphorus | surfaces | | | | | | | |
| | 24 | nickel- | one | 79 | 47 | 47 | 79 | 3 | 3S2B | 10.1 |
| | | phosphorus | surface | | | | | | | |
| | 25 | nickel- | one | 99 | 49 | 48 | 97 | 3 | 3S2B | 11.1 |
| | | phosphorus | surface | | | | | | | |
| | 26 | copper | both | 48 | 48 | 47 | 50 | 3 | 3S2B | 8.0 |
| | | | surfaces | | | | | | | |
| | 27 | ″ | both | 80 | 81 | 82 | 82 | 3 | 3S2B | 9.0 |
| | | | surfaces | | | | | | | |
| | 28 | ″ | both | 50 | 81 | 80 | 53 | 3 | 3S2B | 10.0 |
| | | | surfaces | | | | | | | |
| | 29 | ″ | both | 50 | 102 | 102 | 50 | 3 | 3S2B | 11.1 |
| | | | surfaces | | | | | | | |
| | 30 | ″ | one | 47 | 50 | 50 | 52 | 3 | 3S2B | 8.3 |
| | | | surface | | | | | | | |
| | 31 | ″ | one | 80 | 80 | 81 | 80 | 3 | 3S2B | 9.1 |
| | | | surface | | | | | | | |

TABLE 1-4

| | | Hard metal-plated layer | | | | | | | | Sealing |
|---|---|---|---|---|---|---|---|---|---|---|
| | | | | Amounts of steps | | | | Number | | limit |
| | | | Attached | μm | | | | of metal | Bead | pressure |
| | | Material | surfaces | #1 | #2 | #3 | #4 | plates | structure | MPa |
| Examples | 32 | copper | one | 47 | 80 | 80 | 50 | 3 | 3S2B | 9.9 |
| | | | surface | | | | | | | |
| | 33 | ″ | one | 47 | 103 | 101 | 50 | 3 | 3S2B | 11.0 |
| | | | surface | | | | | | | |
| | 34 | ″ | both | 80 | 49 | 50 | 80 | 3 | 3S2B | 10.0 |
| | | | surfaces | | | | | | | |
| | 35 | ″ | both | 100 | 51 | 50 | 100 | 3 | 3S2B | 11.1 |
| | | | surfaces | | | | | | | |
| | 36 | ″ | one | 80 | 48 | 48 | 81 | 3 | 3S2B | 10.2 |
| | | | surface | | | | | | | |
| | 37 | ″ | one | 100 | 50 | 49 | 100 | 3 | 3S2B | 11.3 |
| | | | surface | | | | | | | |
| | 38 | nickel | one | 49 | 81 | 79 | 50 | 3 | 3S3B | 13.5 |
| | | | surface | | | | | | | |
| | 39 | ″ | both | 47 | 83 | 81 | 50 | 3 | 3S3B | 13.6 |
| | | | surfaces | | | | | | | |
| | 40 | ″ | one | 49 | 84 | 82 | 49 | 2 | 2S2B | 9.4 |
| | | | surface | | | | | | | |
| | 41 | ″ | both | 51 | 81 | 82 | 54 | 2 | 2S2B | 9.1 |
| | | | surfaces | | | | | | | |

TABLE 1-5

| | | Hard metal-plated layer | | | | | | Number | | sealing |
|---|---|---|---|---|---|---|---|---|---|---|
| | | | | Amounts of | | | | of | | limit |
| | | | Attached | steps μm | | | | metal | Bead | pressure |
| | | Material | surfaces | #1 | #2 | #3 | #4 | plates | structure | MPa |
| Comparative | 1 | no step | | 0 | 0 | 0 | 0 | 3 | | 7.0 |
| Examples | 2 | butt joint | | 50 | 51 | 50 | 49 | 3 | | 8.0 |
| | 3 | tin | both | 50 | 51 | 50 | 49 | 3 | | 7.2 |
| | | | surfaces | | | | | | | |

| | | | | | | | |
|---|---|---|---|---|---|---|---|
| 4 | butt joint | 50 | 51 | 50 | 49 | 3 | 12.1 |
| 5 | ″ | 50 | 51 | 50 | 49 | 2 | 7.9 |

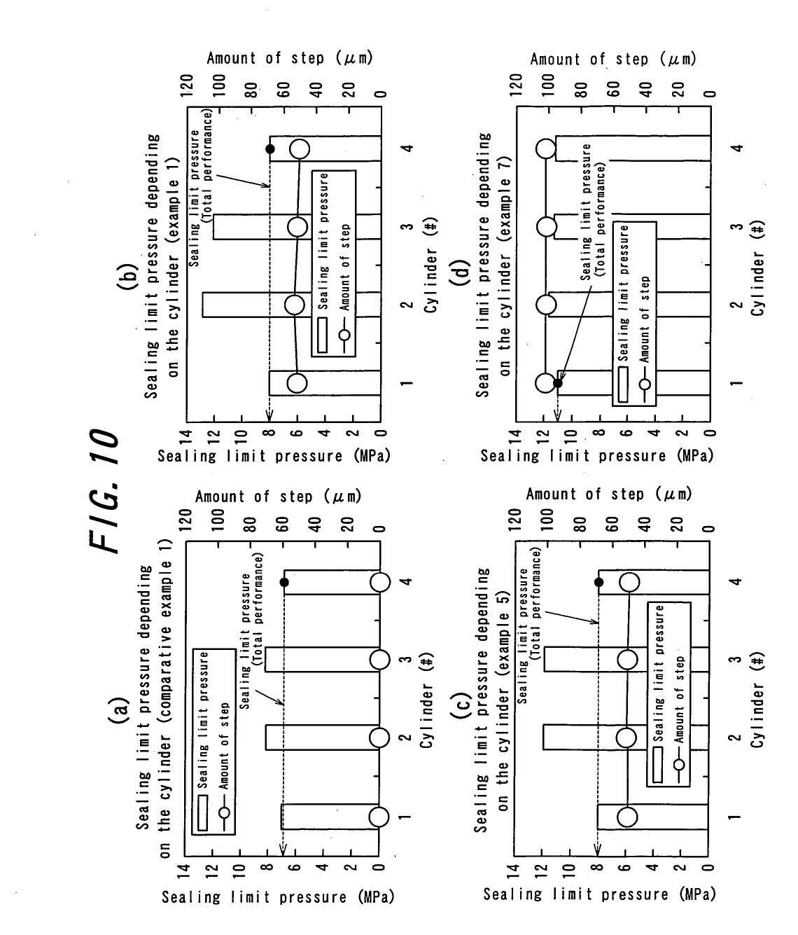

FIGS. 10(a) to 10(d) are explanatory views respectively showing the sealing limit pressure depending on the cylinder (the cylinder bore) in terms of Comparative Example 1 without including the step structure and Examples 1, 5, and 7. From these drawings, it is apparent that the metal gaskets of the above-described examples can improve the sealing properties considerably higher than the one without including the step structure.

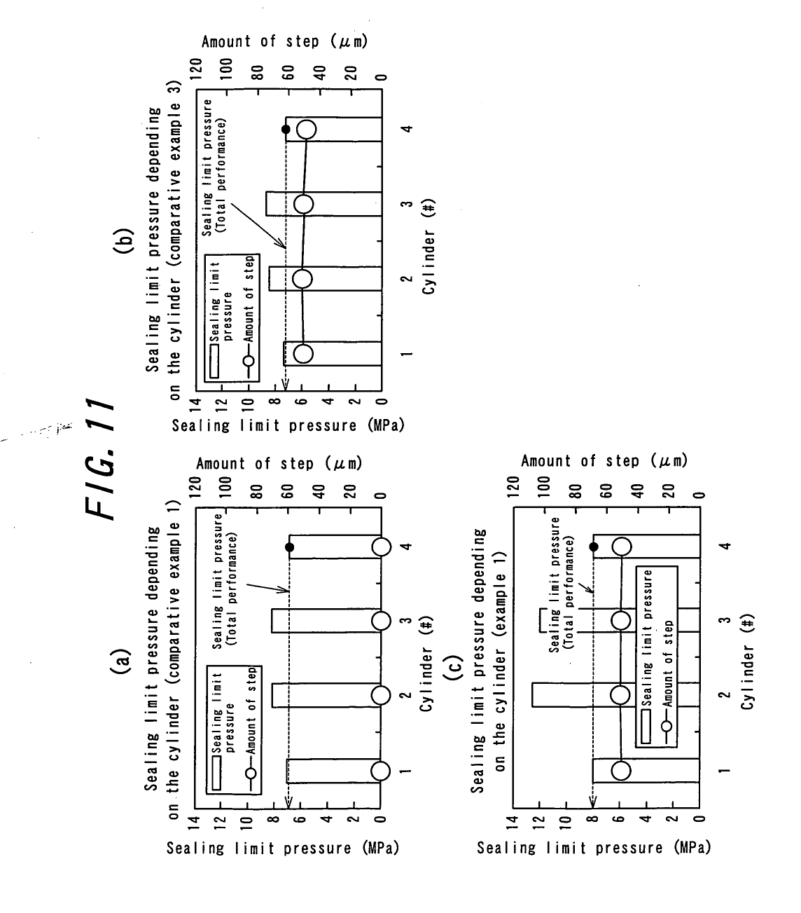

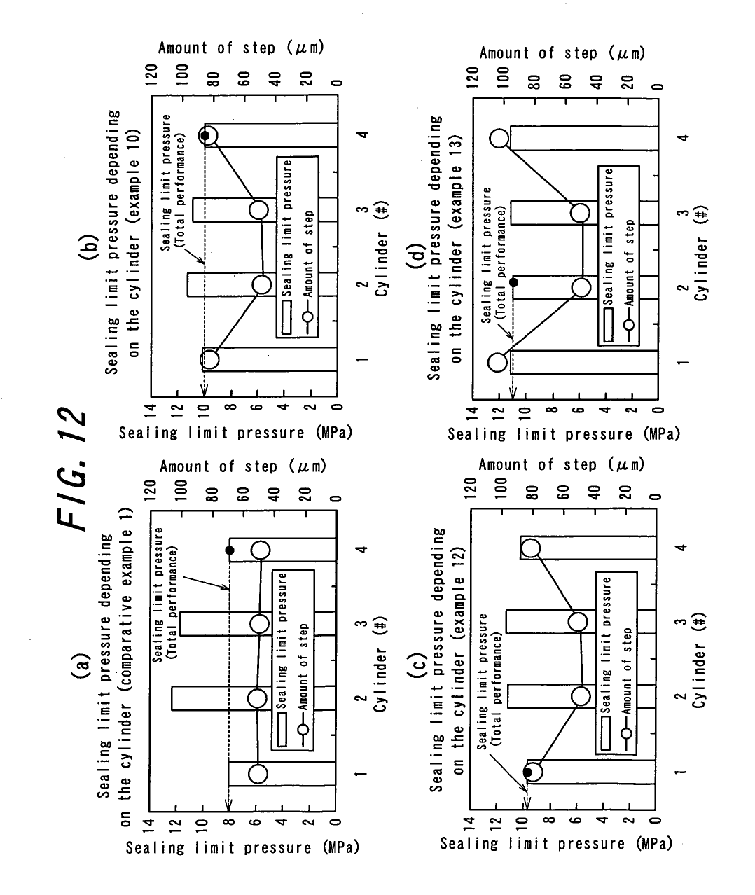

FIGS. 11(a) to 11(c) are explanatory views respectively showing the sealing limit pressure depending on the cylinder (the cylinder bore) in terms of Comparative Example 1 without including the step structure, Comparative Example 3 including the soft surface metal-plated layer, and Example 1. From these drawings, it is apparent that the metal gaskets of the above-described examples can improve the sealing properties higher than the one including the soft surface metal-plated layer.

FIGS. 12(a) to 12(d) are explanatory views respectively showing the sealing limit pressure depending on the cylinder (the cylinder bore) applied to the case where the rigidity distribution of the internal combustion engine is lower concerning the cylinder bores #1 and #4 than the cylinder bores #2 and #3, in terms of Comparative Example 2 setting the constant amounts of the steps and Examples 10, 12, and 13 in which the amounts of the steps are increased in the peripheries of the cylinder holes corresponding to the cylinder bores #1 and #4 more than in the peripheries of the cylinder holes corresponding to the cylinder bores #2 and #3. From these drawings, it is apparent that the metal gaskets of the above-described examples can improve the sealing properties considerably higher than the one setting the constant amounts of the steps.

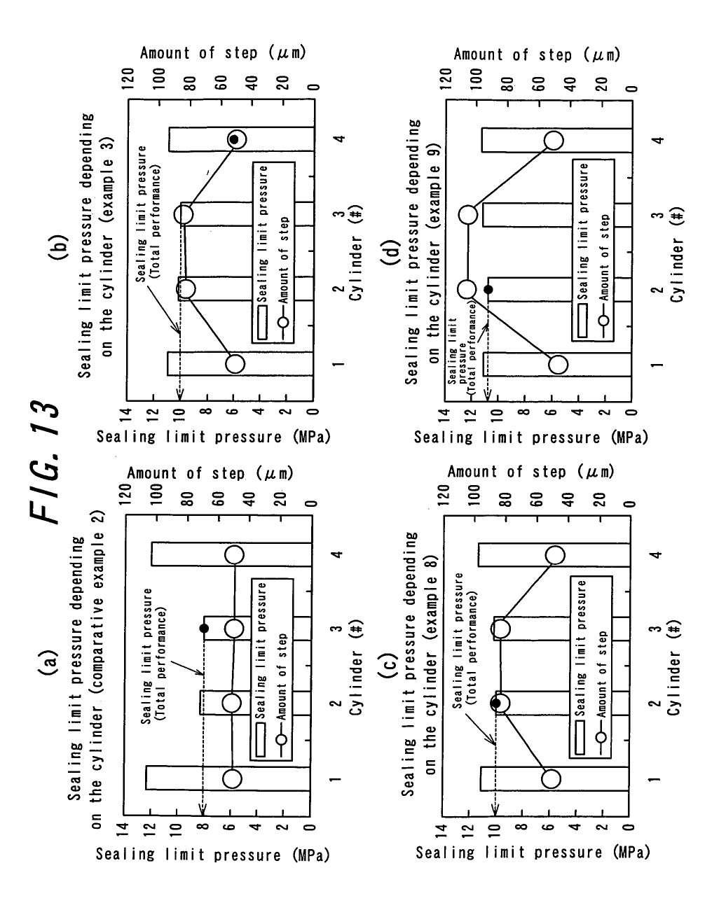

FIGS. 13(a) to 13(d) are explanatory views respectively showing the sealing limit pressure depending on the cylinder (the cylinder bore) applied to the case where the rigidity distribution of the internal combustion engine is lower concerning the cylinder bores #2 and #3 than the cylinder bores #1 and #4, in terms of Comparative Example 2 setting the constant amounts of the steps and Examples 3, 8, and 9 in which the amounts of the steps are increased in the peripheries of the cylinder holes corresponding to the cylinder bores #2 and #3 more than in the peripheries of the cylinder holes corresponding to the cylinder bores #1 and #4. From these drawings, it is apparent that the metal gaskets of the above-described examples can improve the sealing properties considerably higher than the one setting the constant amounts of the steps.

Although this invention has been described based on the illustrated examples, it is to be noted that this invention will not be limited only to the above-described examples. For example, the hard metal-plated layer 5 may be made of iron having the hardness equal to or above Hv 60.

Next, an embodiment according to a second aspect of this invention will be described by use of examples and based on the accompanying drawings. Here, FIG. 1 is a plan view showing the entirety of Example 1 of a metal gasket for a cylinder head of this invention. FIG. 14 is a cross-sectional view taken along the A-A line in FIG. 1. FIGS. 15(a) to 15(c) are explanatory views showing a method of providing a metal foil layer on an auxiliary plate of the metal gasket of the above-described Example 1. In these drawings, similar portions to those shown in FIG. 29 to FIG. 31 described above are indicated with the same reference numerals. Specifically, reference numeral 1 denotes a metal gasket, reference numeral 2 denotes a base plate, and reference numeral 3 denotes an auxiliary plate, respectively.

The metal gasket 1 for a cylinder head of the above-described Example 1 includes two base plates 2 layered over each other, which are made of a steel plate (SUS 301H 0.2t) subjected to rubber coating of a rubber layer made of NBR in the thickness of 25 μm only onto respective outer side surfaces (surfaces facing a cylinder block and a cylinder head), and an auxiliary plate 3 made of a steel plate (SUS 301H 0.2t) without rubber coating which is to be interposed between the base plates 2.

As shown in FIG. 1, each of the two base plates 2 herein includes a plurality of cylinder holes 2a formed so as to correspond respectively to a plurality of cylinder bores on the cylinder block of an internal combustion engine, annular beads 2b of an angled cross-sectional shape (so-called a full bead shape) formed around the respective cylinder holes 2a, a plurality of coolant holes 2c formed at outer peripheral portions of the respective annular beads 2b so as to correspond to coolant jackets on the cylinder block and to coolant holes on the cylinder head of the above-described internal combustion engine, and an outer peripheral bead 2d of a cross-sectional shape sloping on one side (so called a half bead shape) which is formed in a position so as to totally surround the plurality of annular beads 2b and the plurality of coolant holes 2c located in the peripheries thereof.

Moreover, as shown in FIG. 15(a), the auxiliary plate 3 herein includes cylinder holes 3d corresponding to the respective cylinder holes 2a on the base plates 2, and coolant holes 3e corresponding to some of the coolant holes 2c on the above-described base plates 2.

As shown in FIG. 14, the metal gasket 1 for a cylinder head of this Example 1 further includes a metal foil layer 5 on one surface (which is a surface on an upper side in the drawing) of the auxiliary plate 3 in the thickness of 50 μm through an adhesive layer 7. As shown in FIG. 15(b), this metal foil layer 5 is formed by pressing an aluminum foil 6 (A3005 (JIS H4000) made by Nippon Light Metal Co., Ltd) having the thickness of 50 μm and the hardness equal to or above Hv 60, which is cut out into a planar shape corresponding to a planar shape of the peripheral portion of the cylinder hole 3d of the auxiliary plate, onto one of the surfaces of the auxiliary plate 3 while coating a phenol adhesive (Metaloc N23 made by Toyokagaku Kenkyusho Co., Ltd.) on a rear surface thereof, and then heating and attaching the aluminum foil 6 by pressurization with a hot plate pressing machine or the like while interposing the phenol adhesive therebetween. When interposed between the two base plates 2 together with the auxiliary plate 3, the metal foil layer 5 extends from a position more radially inward than the annular bead 2b to a position radially outward together with the adhesive layer 7 made of the phenol adhesive so as to overlap the respective annular beads 2b of the base plates 2 and to face top portions of the annular beads 2b, and thereby annularly surrounds the respective cylinder holes 3d on the auxiliary plate 3 and eventually the respective cylinder holes 2a on the base plates 2 corresponding thereto.

According to the metal gasket 1 of the above-described Example 1, the metal foil layers 5 made of the aluminum foil 6 attached to one of the surfaces of the auxiliary plate 3 to be interposed between the two base plates 2 by means of pressurization and heating extend from the positions more radially inward than the annular beads 2b to the positions radially outward together with the adhesive layer 7 made of the phenol adhesive for attaching the metal foil layer 5 so as to overlap the respective annular beads 2b of the base plates 2 and to face the top portions of the annular beads 2b, and surround the respective cylinder holes 2a on the base plates 2 annularly to constitute a step structure S4 having an amount of the step approximately equal to 50 μm (not including the adhesive layer 7). Therefore, line pressure to be applied to the top portions of the annular beads 2b of the two base plates 2 is increased, and it is possible to exert a high sealing performance against combustion gas pressure inside the cylinder bores as will be described later.

Moreover, according to the metal gasket 1 of this Example 1, the phenol adhesive constituting the adhesive layer 7 attaches the aluminum foil 6 to the auxiliary plate 3 while being heated and pressurized. Therefore, it is possible to form the step structure in a desired thickness easily either by pressing and allowing the phenol adhesive before hardening to flow under the aluminum foil 6 or by extruding part of the adhesive from under the aluminum foil 6, and to obtain an amount of the step easily for optimizing balance of constriction forces between the annular bead 2b and the outer peripheral bead 2d.

In addition, according to the metal gasket 1 of this Example 1, the metal foil applies aluminum having the hardness equal to or above Hv 60. The above-described aluminum foil 6 has high heat resistance, and is break-proof and able to maintain the shape easily. Accordingly, it is easy to handle the metal foil at the time of formation and attachment.

Meanwhile, according to the metal gasket 1 of this Example 1, the phenol adhesive is used as the adhesive for the adhesive layer 7. Since the phenol adhesive has high heat resistance, it is possible to maintain high heat resistance of the gasket.

Moreover, according to the metal gasket 1 of this Example 1, the outer surfaces of the respective steel plates in the two base plates 2 are subjected to rubber coating to be covered with the rubber layers. Therefore, it is possible to improve the sealing performance as the rubber layers perform a function as micro sealing by burying small scratches and processing scars on deck surfaces of the cylinder block and the cylinder head.

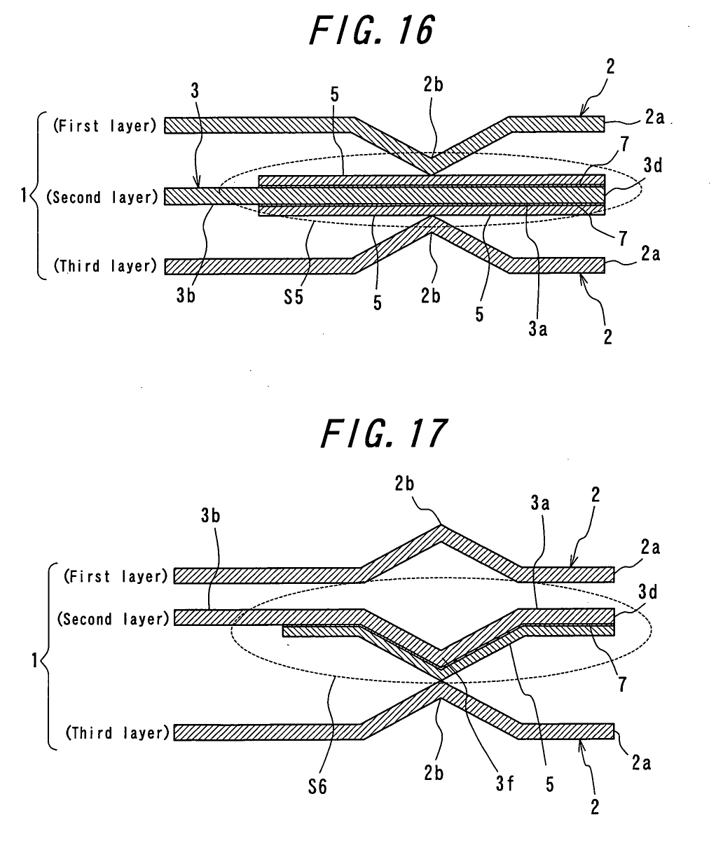

FIG. 16 is a cross-sectional view of a metal gasket for a cylinder head according to Example 2 of this invention in a similar position to FIG. 1. The metal gasket 1 of this Example 2 is only different from the foregoing Example 1 in that the metal foil layers 5 are provided on both surfaces of the auxiliary plate 3 each in the thickness of 25 μm through the adhesive layers 7, which are formed by heating and attaching the aluminum foils 6 (A3005 made by Nippon Light Metal Co., Ltd) each having the thickness of 25 μm onto the both surfaces of the auxiliary plate 3 by pressurization while interposing the phenol adhesive, and thereby constituting a step structure S5 having an amount of a step equal to 50 μm (not including the adhesive layers 7). Other features are identical to those in Example 1. According to this Example 2, it is also possible to obtain similar operations and effects to those in the forgoing Example 1.

Here, ones which apply a similar configuration to Example 1 including the adhesive layer 7 and the metal foil layer 5 on one of the surfaces of the flat auxiliary plate 3 except that the metal foil 6 of the metal foil layer 5 in the thickness of 50 μm is replaced by steel (SPCC) and stainless steel (SUS304) respectively having the hardness equal to or above Hv 60 while using the phenol adhesive as the adhesive will be defined as Example 3 and Example 4 of the metal gaskets for a cylinder head of this invention. According to these Examples 3 and 4, it is also possible to exert high sealing performances as similar to the foregoing examples as will be described later.

Meanwhile, ones which apply a similar configuration to Example 1 including the adhesive layer 7 and the metal foil layer 5 on one of the surfaces of the flat auxiliary plate 3 except that the metal foil 6 of the metal foil layer 5 in the thickness of 50 μm is replaced by brass and titanium respectively having the hardness equal to or above Hv 60 while using the phenol adhesive as the adhesive will be defined as Example 5 and Example 6 of the metal gaskets for a cylinder head of this invention. According to these Examples 5 and 6, it is also possible to exert high sealing performances as similar to the foregoing examples as will be described later.

Moreover, ones which apply a similar configuration to Example 1 including the adhesive layer 7 and the metal foil layer 5 on one of the surfaces of the flat auxiliary plate 3 except that the adhesive is respectively replaced by an epoxy adhesive and a polyimide adhesive while using aluminum having the thickness of 50 μm and the hardness equal to or above Hv 60 as the metal foil 6 of the metal foil layer 5 will be defined as Example 7 and Example 8 of the metal gaskets for a cylinder head of this invention. According to these Examples 7 and 8, it is also possible to exert high sealing performances as similar to the foregoing examples as will be described later.

FIG. 17 is a cross-sectional view of a metal gasket for a cylinder head according to Example 9 of this invention in a similar position to FIG. 1. This metal gasket 1 of Example 9 is only different from the foregoing Example 1 in that an annular bead 3f of an angled cross-sectional shape is formed on the auxiliary plate 3 so as to overlap the annular beads 2b of the base plates 2 and to allow a top position to face a top position of the annular bead 2b of the base plate 2 on the lower side, and that the metal foil layer 5 is provided on one surface (on the protruding side of the annular bead 3f) of the auxiliary plate 3 in the thickness of 50 μm through the adhesive layer 7, which is formed by heating and attaching the aluminum foil 6 in the thickness of 50 μm onto one of the surfaces of the auxiliary plate 3 by pressurization while interposing the phenol adhesive, and thereby constituting a step structure S6 having an amount of a step equal to 50 μm (not including the adhesive layers 7). Other features are identical to those in Example 1. According to this Example 9, the annular beads 2b and 3f are stacked in three layers, and it is possible to obtain a higher sealing performance than the foregoing Example 1 as will be described later.

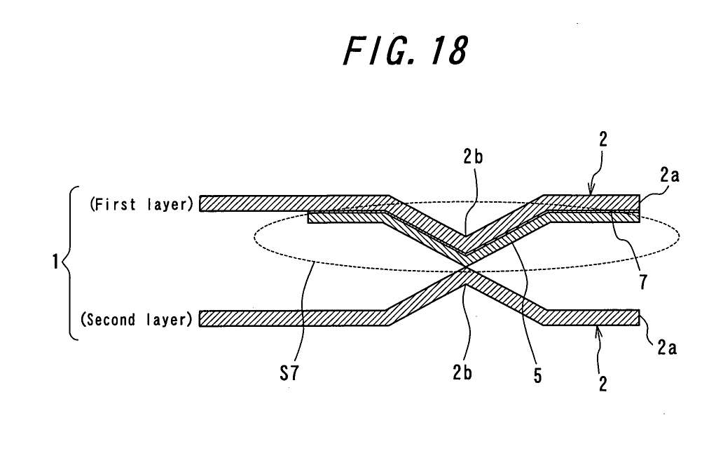

FIG. 18 is a cross-sectional view of a metal gasket for a cylinder head according to Example 10 of this invention in a similar position to FIG. 1. This metal gasket 1 of Example 10 does not include the auxiliary plate 3 between the two base plates 2. However, the respective base plates 2 are similar to those in the foregoing examples. Moreover, in this example, the metal foil layer 5 is provided on one of the base plates 2 (which is located on the upper side in the drawing) on a surface (an inner side surface) facing the other base plate (which is the base plate on the lower side in the drawing) 2 while interposing the adhesive layer 7. This metal foil layer 5 is formed by pressing the aluminum foil 6 in the thickness of 50 μm, which is cut out into a planar shape corresponding to a planar shape of a peripheral portion of the cylinder hole 2a of the base plate 2, onto one surface (on the protruding side of the annular bead 2b) of the base plate 2, and then heating and attaching the aluminum foil 6 by pressurization while interposing a polyimide film as the adhesive. When interposed between the two base plates 2, the metal foil layer 5 extends from a position more radially inward than the annular bead 2b to a position radially outward together with the adhesive layer 7 made of the polyimide film so as to overlap the respective annular beads 2b of the base plates 2 and to face top portions of the annular beads 2b, and thereby annularly surrounds the respective cylinder holes 2a on the base plates 2 to constitute a step structure S7 having the amount of the step equal to 50 μm.

According to the metal gasket 1 of the above-described Example 10, it is possible to manufacture the gasket at low costs because there is no auxiliary plate 3. Moreover, it is also possible to obtain a substantially equivalent sealing performance to the foregoing Example 1 as will be described later.

The following Table 2-1 shows comparison of the configurations and the sealing performances among the metal gaskets of the above-described Example 1 to Example 10, and a metal gasket of Comparative Example configured to remove the metal foil layer 5 and the adhesive layer 7 from Example 1. Concerning the sealing performance herein, as shown in FIG. 7, each of the metal gaskets 1 described above is placed between the cylinder block SB and the cylinder head SH of an automobile engine, and the head bolts HB are tightened at the prescribed axial force (34.4 kN/bolt) to form a specimen by subjecting a piston inside the cylinder bore and a valve in a combustion chamber to a hermetic sealing process. Then, the specimen is subjected to a thermal degradation test in an oven at a thermal degradation temperature at 200° C. and for a thermal degradation time period of 400 hours. The sealing performance on the table represents a result of measurement of sealing limit pressure of the specimen by injecting air from an ignition plug hole into the cylinder bore in a room-temperature atmosphere and then increasing pressure inside the cylinder bore in the beginning prior to the thermal degradation test and after the thermal degradation.

TABLE 2-1
(p33)

| | | | | | | | Sealing | |
|---|---|---|---|---|---|---|---|---|
| | | | | | | Number | performance | |
| | | | | | | of | MPa | |
| | | Metal foil layer | | | | annular | | After |
| | | | Thickness | | | bead | Initial | thermal |
| | | Attachment | μm | Material | Adhesive | layers | state | degradation |
| Examples | 1 | one | 50 | aluminum: | phenol: made | 2 | 10.8 | 10.4 |
| | | surface | | made by | by Toyokagaku | | | |
| | | | | Nippon Light | Kenkyusho | | | |
| | | | | Metal Co., Ltd. | Co., Ltd | | | |
| | | | | A 3005 | Metaloc N23 | | | |
| | | | | JIS H 4000 | | | | |
| | 2 | both | 25 | aluminum: | phenol: made | 2 | 9.8 | 10.1 |
| | | surfaces | | made by | by Toyokagaku | | | |
| | | | | Nippon Light | Kenkyusho | | | |
| | | | | Metal Co., Ltd. | Co., Ltd | | | |
| | | | | A 3005 | Metaloc N23 | | | |
| | | | | JIS H 4000 | | | | |
| | 3 | one | 50 | steel: made by | phenol: made | 2 | 10.5 | 10.4 |
| | | surface | | Kawasaki Steel | by Toyokagaku | | | |
| | | | | Corporation | Kenkyusho | | | |
| | | | | JIS SPCC | Co., Ltd | | | |
| | | | | | Metaloc N23 | | | |
| | 4 | one | 50 | stainless steel: | phenol: made | 2 | 10.1 | 10.1 |
| | | surface | | made by | by Toyokagaku | | | |
| | | | | Sumitomo | Kenkyusho | | | |
| | | | | Metal | Co., Ltd | | | |
| | | | | Industries Ltd. | Metaloc N23 | | | |
| | | | | JIS G 4305 | | | | |
| | | | | SUS304 | | | | |
| | 5 | one | 50 | bronze: made | phenol: made | 2 | 9.9 | 9.5 |
| | | surface | | by Fukuda | by Toyokagaku | | | |
| | | | | Metal Foil & | Kenkyusho | | | |
| | | | | Powder Co., | Co., Ltd | | | |
| | | | | Ltd. | Metaloc N23 | | | |
| | | | | JIS H 3110 | | | | |
| | 6 | one | 50 | titanium: made | phenol: made | 2 | 11.1 | 10.6 |
| | | surface | | by Fukuda | by Toyokagaku | | | |
| | | | | Metal Foil & | Kenkyusho | | | |
| | | | | Powder Co., | Co., Ltd | | | |
| | | | | Ltd. | Metaloc N23 | | | |
| | | | | JIS H 4600 | | | | |
| | 7 | one | 50 | aluminum: | epoxy: made by | 2 | 10.3 | 9.8 |
| | | surface | | made by | Cemedine Co., | | | |
| | | | | Nippon Light | Ltd. | | | |
| | | | | Metal Co., Ltd. | EP-160 | | | |
| | | | | A 3005 | | | | |
| | 8 | one | 50 | aluminum: | polyimide: | 2 | 10.7 | 10.6 |
| | | surface | | made by | made by New | | | |
| | | | | Nippon Light | Japan Chemical | | | |
| | | | | Metal Co., Ltd. | Co., Ltd | | | |
| | | | | A 3005 | Rikamato | | | |
| | | | | | PN-20 | | | |
| | 9 | one | 50 | aluminum: | phenol: made | 3 | 13.8 | 13.3 |
| | | surface | | made by | by Road | | | |
| | | | | Nippon Light | Corporation | | | |
| | | | | Metal Co., Ltd. | Chemlock #254 | | | |
| | | | | A 3005 | | | | |
| | 10 | one | 50 | aluminum: | polyimide film | 2 | 9.9 | 9.5 |
| | | surface | | made by | | | | |
| | | | | Nippon Light | | | | |
| | | | | Metal Co., Ltd. | | | | |
| | | | | A 3005 | | | | |

| | | | | |
|---|---|---|---|---|
| Comparative | none | 2 | 7.3 | 6.7 |
| Example | | | | |

From this Table 2-1, it is apparent that the sealing performances and the heat resistant performances of the metal gaskets of the above-described examples are considerably higher than those of Comparative Example.

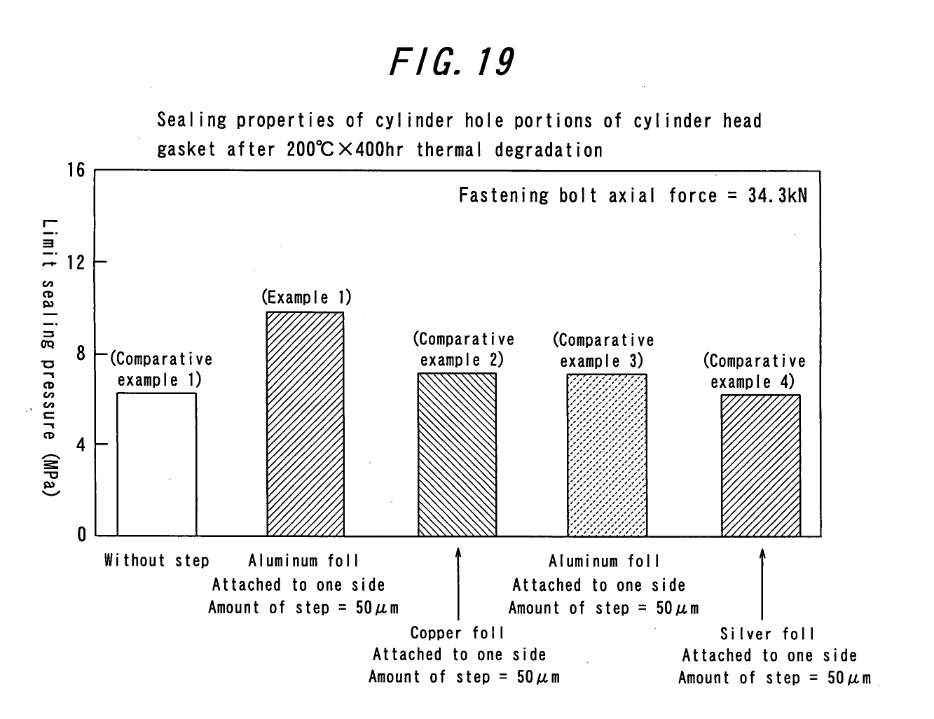

FIG. 19 is an explanatory view showing comparison of sealing performances after thermal degradation at the thermal degradation temperature of 200° C. and for the thermal degradation time period of 400 hours among the above-described Example 1, Comparative Example 1 identical to the foregoing comparative example, and Comparative Examples 2 to 4 applying the same structure as the above-described Example 1 but only having the difference in the material of the metal foil layer 5. From this FIG. 19, it is apparent that the metal gasket of the above-described example applying the aluminum foil 6 as the metal foil layer 5 has the considerably higher heat resistant performance as compared to Comparative Example 2 applying a copper foil as the metal foil layer 5, Comparative Example 3 applying a magnesium foil as the metal foil layer 5, and Comparative Example 4 applying a silver foil as the metal foil layer 5.

Although this invention has been described based on the illustrated examples, it is to be noted that this invention will not be limited only to the above-described examples. For example, the surfaces of the base plates 2 and the auxiliary plate 3 where the metal foil layers 5 are formed may be provided with rubber coating.

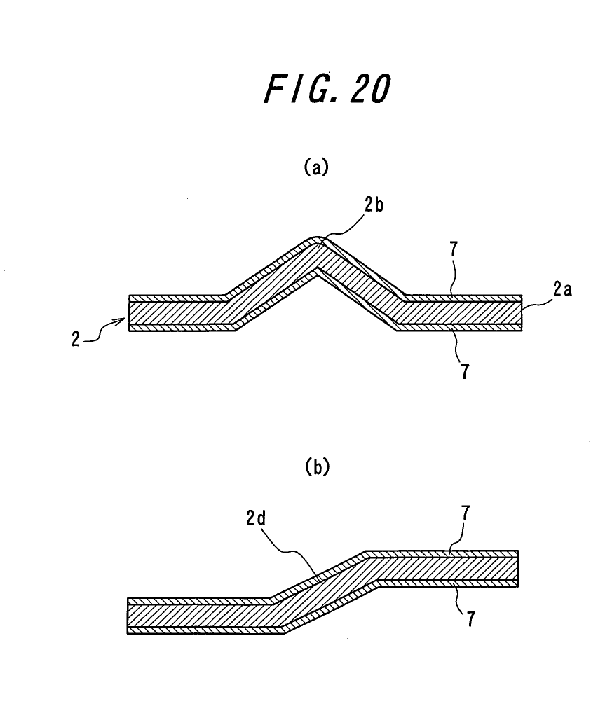

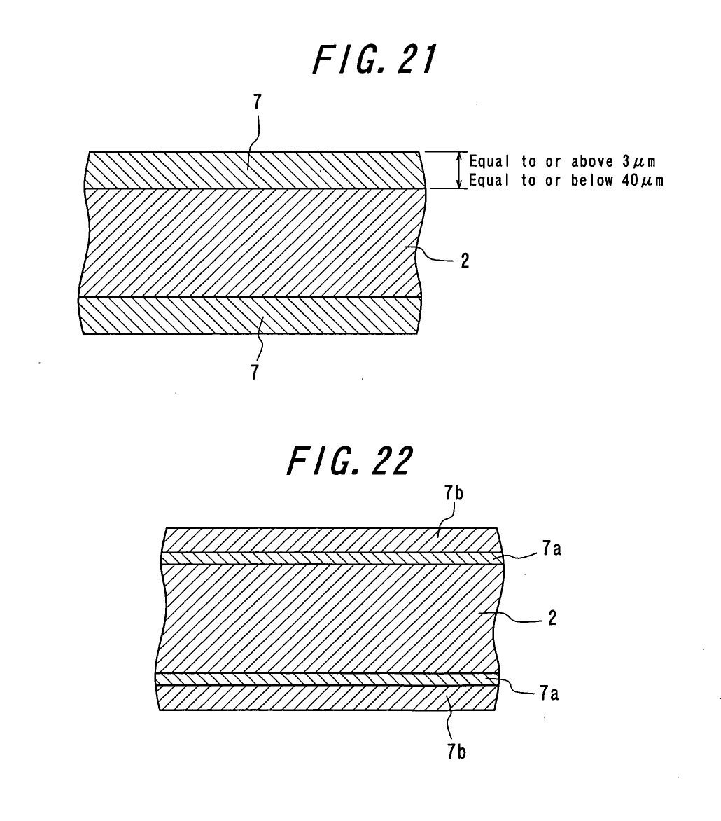

Lastly, an embodiment according to a third aspect of this invention will be described by use of examples and based on the accompanying drawings. Here, FIG. 1 is a plan view showing the entirety of Example 1 of a metal gasket for a cylinder head of this invention. FIGS. 20(a) and 20(b) are cross-sectional views of a single base plate taken along the A-A line and the B-B line in FIG. 1. FIG. 21 is an enlarged cross-sectional view showing a base plate and soft surface metal-plated layers of the metal gasket according to the above-described example. Similar portions to those shown in FIG. 29 to FIG. 31 described above are indicated with the same reference numerals. Specifically, reference numeral 1 denotes a metal gasket, and reference numeral 2 denotes a base plate, respectively.

The metal gasket 1 for a cylinder head of the above-described example includes two base plates 2 layered over each other, which are respectively made of a steel plate (SUS 301H 0.2t) without rubber coating, and includes an auxiliary plate 3 made of a steel plate (SUS 301H 0.2t) without rubber coating which is to be interposed between the base plates 2.

As shown in FIG. 1, each of the two base plates 2 herein includes a plurality of cylinder holes 2a formed so as to correspond respectively to a plurality of cylinder bores on a cylinder block of an internal combustion engine, annular beads 2b (having the height of 0.25 mm in this example) of an angled cross-sectional shape (so-called a full bead shape) formed around the respective cylinder holes 2a, a plurality of coolant holes 2c formed at outer peripheral portions of the respective annular beads 2b so as to correspond to coolant jackets on the cylinder block and to coolant holes on a cylinder head of the above-described internal combustion engine, and an outer peripheral bead 2d of a cross-sectional shape sloping on one side (so called a half bead shape) which is formed in a position so as to totally surround the plurality of annular beads 2b and the plurality of coolant holes 2c located in the peripheries thereof.

Moreover, the auxiliary plate 3 herein has a contour coinciding with the above-described base plates 2, and includes cylinder holes 3d corresponding to the respective cylinder holes 2a on the base plates 2, and coolant holes 3e corresponding to some of the coolant holes 2c on the above-described base plates 2.

The metal gasket 1 for a cylinder head of this example further includes soft surface metal-plated layers 7 on both surfaces of the base plate 2 having the thickness in a range from 3 μm to 40 μm inclusive on both surfaces so as to cover the entire surfaces of the respective surfaces. As shown in FIG. 21, these soft surface metal-plated layers 7 are made of a single layer of any of tin, copper, silver, and alloys thereof and are formed on the both surfaces of the base plates 2 in accordance with an electroplating process or a molten metal plating process, for example. The soft surface metal-plated layers 7 have the surface hardness equal to or below Hv 60.

According to the metal gasket 1 of the above-described example, the soft surface metal-plated layers 7 formed on the both surfaces of the base plates 2 so as to cover the entire surfaces of the respective surfaces perform a function of micro sealing as surface sealing layers by burying small scratches and processing scars on deck surfaces of the cylinder block and the cylinder head. In this way, it is possible to exert high sealing properties. Moreover, according to the metal gasket of this example, since the soft surface metal-plated layers 7 are made of metal, it is possible to exert high heat resistance at the annular beads 2b around the cylinder holes 2a exposed to high heat in particular.

In addition, according to the metal gasket 1 of this example, the soft surface metal-plated layer 7 is made of the single layer of any of tin, copper, silver, and alloys thereof, and has the surface hardness equal to or below Hv 60. Therefore, it is possible to exert high sealing property by burying small scratches and processing scars on the deck surfaces easily.

Moreover, according to the metal gasket 1 of this example, the thickness of the soft surface metal-plated layer 7 is set in the range from 3 μm to 40 μm inclusive. Therefore, it is possible to bury small scratches and processing scars on the deck surfaces sufficiently without using an extra plating material.

FIG. 22 is an enlarged cross-sectional view showing a base plate and soft surface metal-plated layers of a metal gasket according to another example of this invention. This example is only different from the foregoing example in that each soft surface metal-plated layer 7 includes two layers, namely, a base layer 7a and a surface layer 7b viewed from the closer side to the base plate 2, and that the surface hardness of the surface layer 7b is set equal to or below Hv 60. Other features are configured as similar to the foregoing example.

According to the metal gasket 1 of this example, in addition to a capability of exerting similar operations and effects to those in the foregoing example, it is only necessary to apply soft metal to the surface layer 7b because the soft surface metal-plated layer 7 includes the two layers of the base layer 7a and the surface layer 7b. In this way, it is possible to select hard metal which can achieve good adhesion to the base plate 2 as the metal for the base layer, and thereby to improve durability of the soft surface metal-plated layer 7 and eventually of the metal gasket 1.

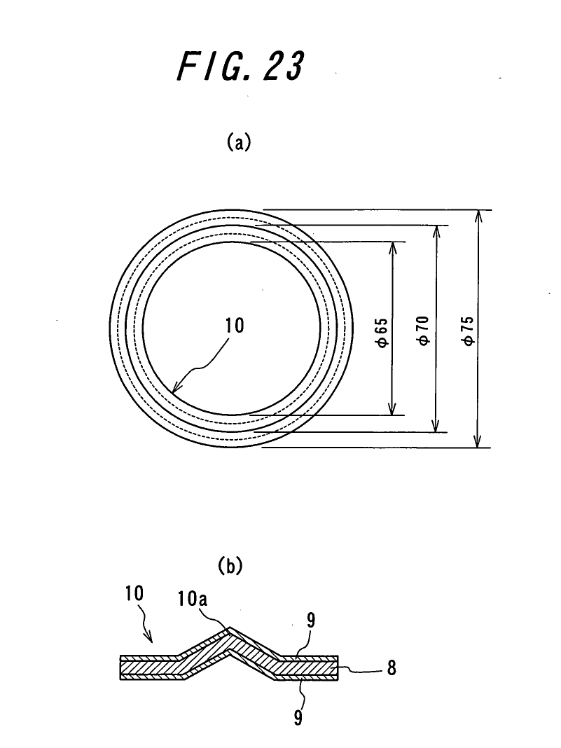

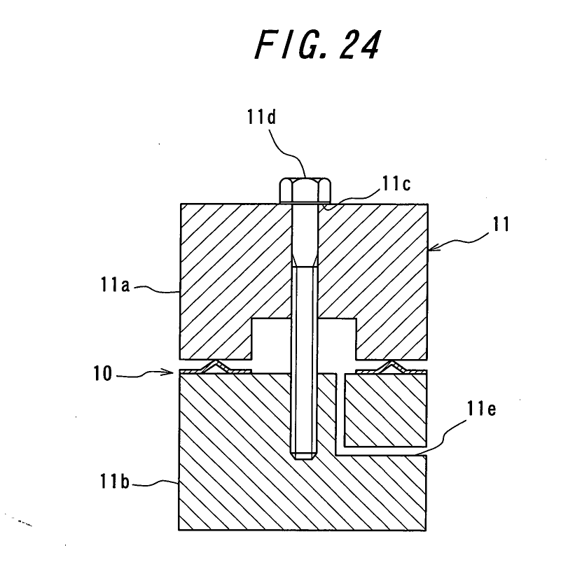

Next, methods and results of sealing tests for confirming the sealing properties of the above-described examples will be described. FIGS. 23(a) and 23(b) are a plan view and a half cross-sectional view showing a shape and dimensions of a gasket test piece, and FIG. 24 is a cross-sectional view showing an outline of a sealing test apparatus. In this test, as shown in FIGS. 23(a) and 23(b), a gasket 10 having dimensions of an outside diameter of 75 mm, an inner diameter of 65 mm, and a middle diameter of a bead of 70 mm, and being formed by providing surface coating layers 9 on both surfaces of a thin plate 8 made of metal is used as a test piece. As shown in FIG. 24, the gasket 10 is interposed between an upper flange 11a and a lower flange 11b, which are respectively made of an aluminum alloy, of a sealing test apparatus 11 and an unillustrated strain gauge is attached thereto. The gasket 10 is fastened by a fastening bolt 11d attaching a sealing washer 11c, and limit sealing pressure is measured by introducing high-pressure air from a pressurization passage 11e to inside in a submerged state and confirming existence of leakage. Here, the following test conditions are set up, namely, fastening line pressure equal to 40 N/mm, a fastening force equal to 8796 N, the fastening bolt equivalent to M10, the material of the flanges equivalent to A500 series, the outside diameters of the flanges equal to 75 mm, the height of the respective flanges equal to 50 mm, surface roughness equal to 9.7 μm (Rmax), a pressure detection medium of air, and a testing temperature at a room temperature.

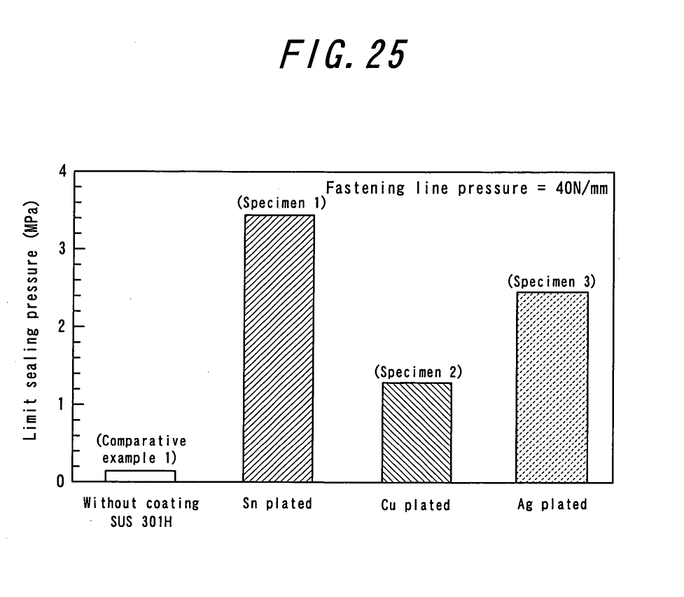

FIG. 25 shows results of performing the above-described sealing tests in terms of Specimens 1 to 3 configured to apply tin (Sn), copper (Cu), and silver (Ag) respectively as a metal plating material of the surface coating layers 9 of the gasket 10 as shown in the following Table 3-1, and in terms of Comparative Example 1 which is the gasket without the surface coating layers 9. As shown in the drawing, every specimen has an extremely high limit sealing pressure as compared to Comparative Example 1. Particularly, Specimen 1 plated with tin having the lowest hardness has the highest limit sealing pressure. Note that the respective “specimens” including the following satisfy the conditions of the soft surface metal-plated layer 7 of the foregoing example.

TABLE 3-1
(p37)

| | | | | Metal thin plate | | | |
|---|---|---|---|---|---|---|---|
| | Surface coating | | | base material | | Bead shape | |
| No. | Material | Layer thickness | Hardness | Material | Plate thickness | Shape | Height |
| Specimen 1 | Sn | 25 μm | 12 Hv | SUS301H | 0.2 mm | full bead | 0.25 mm |
| | plating | | | | | | |
| specimen 2 | Cu | 25 μm | 58 Hv | SUS301H | 0.2 mm | full bead | 0.25 mm |
| | plating | | | | | | |
| Specimen 3 | Ag | 25 μm | 23 Hv | SUS301H | 0.2 mm | full bead | 0.25 mm |
| | plating | | | | | | |

| | | | | | |
|---|---|---|---|---|---|
| Comparative | no surface coating | SUS301H | 0.2 mm | full bead | 0.25 mm |
| Example 1 | | | | | |

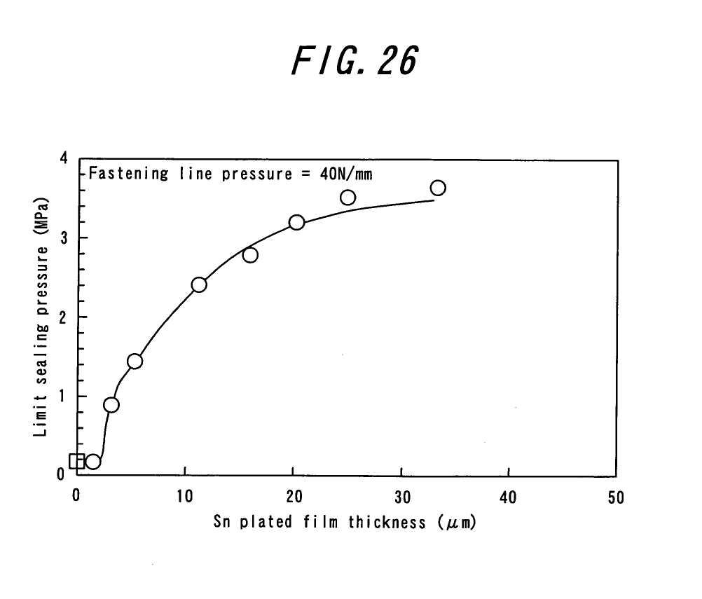

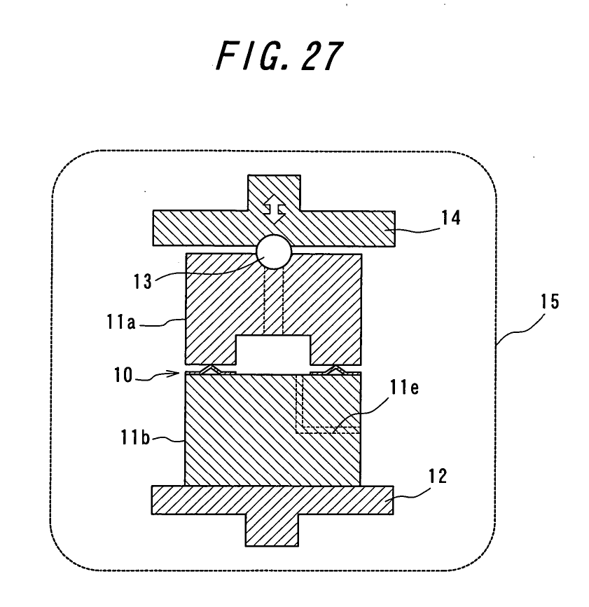

FIG. 26 shows results of performing the above-described sealing tests in terms of Specimens 1 to 8 (indicated with ∘ in the drawing) configured to apply tin (Sn) as the metal plating material of the surface coating layers 9 of the gasket 10 in the various thicknesses as shown in the following Table 3-2, and in terms of Comparative Example 1(indicated with □ in the drawing) which is the gasket 10 without the surface coating layers 9. As shown in the drawing, it is apparent that the sealing property is improved when the thickness of the plated layer (film) is equal to or above 3 μm and remains almost unchanged when it exceeds 40 μm.

TABLE 3-2
(p39)

| | | | Metal thin plate | | | |
|---|---|---|---|---|---|---|
| | Surface coating | | base material | | Bead shape | |
| No. | Material | Layer thickness | Material | Plate thickness | Shape | Height |
| Specimen 1 | Sn plating | 2 μm | SUS301H | 0.2 mm | full bead | 0.25 mm |
| Specimen 2 | ″ | 3 μm | SUS301H | 0.2 mm | full bead | 0.25 mm |
| Specimen 3 | ″ | 5 μm | SUS301H | 0.2 mm | full bead | 0.25 mm |
| Specimen 4 | ″ | 11 μm | SUS301H | 0.2 mm | full bead | 0.25 mm |
| Specimen 5 | ″ | 16 μm | SUS301H | 0.2 mm | full bead | 0.25 mm |
| Specimen 6 | ″ | 21 μm | SUS301H | 0.2 mm | full bead | 0.25 mm |
| Specimen 7 | ″ | 25 μm | SUS301H | 0.2 mm | full bead | 0.25 mm |
| Specimen 8 | ″ | 34 μm | SUS301H | 0.2 mm | full bead | 0.25 mm |

| | | | | | |
|---|---|---|---|---|---|
| Comparative | no surface coating | SUS301H | 0.2 mm | full bead | 0.25 mm |
| Example 1 | | | | | |

FIG. 27 is a cross-sectional view showing an outline of a method of a thermal degradation test. In this test, the above-described gasket 10 is used as a test piece, and the gasket 10 is interposed between an upper flange 11a and a lower flange 11b, which are respectively made of an aluminum alloy, of a sealing test apparatus 11. The sealing test apparatus 11 is placed on a pedestal 12 inside a heating oven 15, then a variable compression load is applied from a compression flange 14 to the sealing test apparatus 11 through an aligning steel ball 13 in a high temperature environment at 200° C., and the limit sealing pressure is measured before and after the thermal degradation test. Here, the following test conditions are set up, namely, the temperature at 200° C., the maximum compression load at 8796 N, the minimum compression load at 4398 N, a variation frequency at 20 Hz (a sinusoidal waveform), and the number of applied cycles equal to 5×10⁶ times. The method and conditions of the sealing test are similar to the foregoing case.

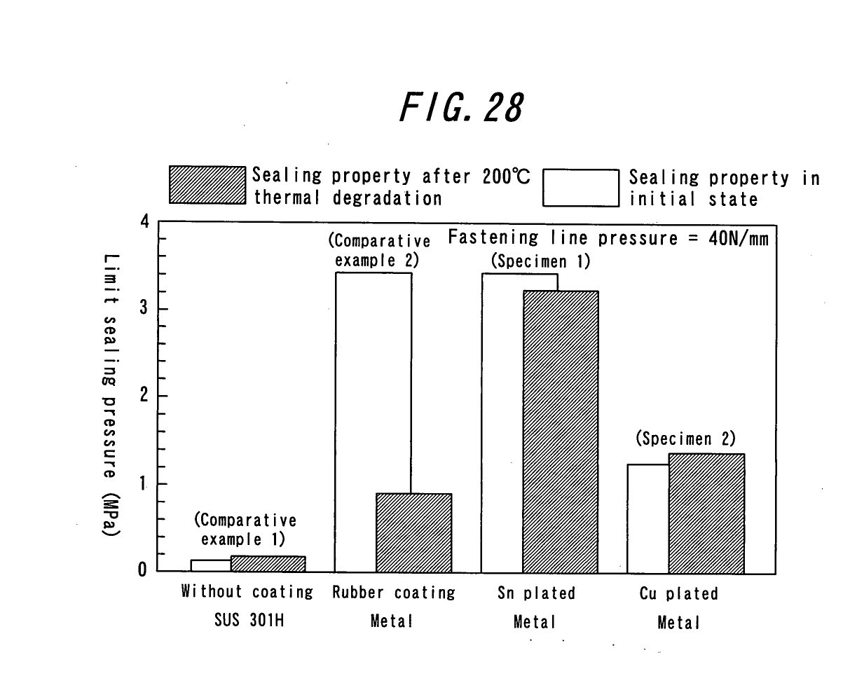

FIG. 28 shows results of performing the above-described thermal degradation tests and the sealing tests before and after the thermal degradation tests in terms of Specimens 1 and 2 configured to apply tin (Sn) and copper (Cu) as the metal plating materials of the surface coating layers 9 of the gasket 10, Comparative Example 1 which is the gasket 10 without the surface coating layers 9, and Comparative Example 2 configured to form the surface coating layers 9 of the gasket 10 by rubber coating as shown in the flowing Table 3-3. As shown in the drawing, it is apparent that heat resistant sealing properties are improved in Specimens 1 and 2 applying tin (Sn) and copper (Cu) as the metal plating materials of the surface coating layers 9 due to little degradation of the surface sealing layers owing to thermal degradation.

TABLE 3-3
(p41)

| | | | | Metal thin plate | | | |
|---|---|---|---|---|---|---|---|
| | Surface coating | | | base material | | Bead shape | |
| No. | Material | Layer thickness | Hardness | Material | Plate thickness | Shape | Height |
| Specimen 1 | Sn | 25 μm | 12 Hv | SUS301H | 0.2 mm | full bead | 0.25 mm |
| | plating | | | | | | |
| Specimen 2 | Cu | 25 μm | 58 Hv | SUS301H | 0.2 mm | full bead | 0.25 mm |
| | plating | | | | | | |
| Comparative | no surface coating | | | SUS301H | 0.2 mm | full bead | 0.25 mm |
| Example 1 | | | | | | | |
| Comparative | rubber | 25 μm | — | SUS301H | 0.2 mm | full bead | 0.25 mm |
| Example 2 | coating | | | | | | |

In the following, results of the execution of the above-described thermal degradation tests and the sealing tests before and after the thermal degradation tests in terms of various other specimens and comparative examples will be described.

Table 3-4 shows results of the tests in terms of Specimen 1 constructed similarly to the gasket 10 by forming tin plated layers in the thickness of 20 μm on both surfaces of a SUS301H stainless steel thin plate having the plate thickness of 0.2 mm by an electroplating process, and then forming a full bead on that steel plate. According to this Specimen 1, it is possible to ensure a stable sealing property both in the initial state prior to the thermal degradation test and after the thermal degradation test.

TABLE 3-4
(p42)

| | | | | Metal thin plate | | | | | |
|---|---|---|---|---|---|---|---|---|---|
| | Surface coating | | | base material | | | | Sealing property | |
| | | Layer | Plating | | Plate | Bead shape | | Initial | After thermal |
| No. | Material | thickness | method | Material | thickness | Shape | Height | state | degradation |
| Specimen 1 | Sn | 20 μm | electroplating | SUS301H | 0.2 mm | full | 0.25 mm | 3.25 MPa | 2.90 MPa |
| | plating | | | | | bead | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-5 shows results of the tests in terms of Specimen 1 constructed similarly to the gasket 10 by forming copper plated layers in the thickness of 30 μm on both surfaces of a SUS301H stainless steel thin plate having the plate thickness of 0.2 mm by an electroplating process, and then forming a full bead on that steel plate. According to this Specimen 1, it is possible to ensure a stable sealing property both in the initial state prior to the thermal degradation test and after the thermal degradation test.

TABLE 3-5
(p44)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Cu | 30 μm | electroplating | SUS301H | 0.2 mm | full | 0.25 mm | 1.25 MPa | 1.35 MPa |
| | plating | | | | | bead | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-6 shows results of the tests in terms of Specimen 1 constructed similarly to the gasket 10 by forming silver plated layers in the thickness of 15 μm on both surfaces of a SUS301H stainless steel thin plate having the plate thickness of 0.2 mm by an electroplating process, and then forming a full bead on that steel plate. According to this Specimen 1, it is possible to ensure a stable sealing property both in the initial state prior to the thermal degradation test and after the thermal degradation test.

TABLE 3-6
(p46)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Ag | 15 μm | electroplating | SUS301H | 0.2 mm | full | 0.25 mm | 2.45 MPa | 2.50 MPa |
| | plating | | | | | bead | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-7 shows results of the tests in terms of Specimen 1 constructed similarly to the gasket 10 by forming gold (Au) plated layers being soft metal in the thickness of 10 μm on both surfaces of a SUS301H stainless steel thin plate having the plate thickness of 0.2 mm by an electroplating process, and then forming a full bead on that steel plate. According to this Specimen 1, it is possible to ensure a stable sealing property both in the initial state prior to the thermal degradation test and after the thermal degradation test.

TABLE 3-7
(p48)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Au | 10 μm | electroplating | SUS301H | 0.2 mm | full | 0.25 mm | 1.75 MPa | 1.60 MPa |
| | plating | | | | | bead | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-8 shows results of the tests in terms of Comparative Example 1 constructed similarly to the gasket 10 by forming iron (Fe) plated layers in the thickness of 35 μm on both surfaces of a SUS301H stainless steel thin plate having the plate thickness of 0.2 mm by an electroplating process, and then forming a full bead on that steel plate. The surface hardness of the plated layer is too high in this Comparative Example 1. Accordingly, it is not possible to obtain a sufficient sealing effect and to ensure a favorable sealing property.

TABLE 3-8
(p50)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Fe | 35 μm | electroplating | SUS301H | 0.2 mm | full | 0.25 mm | 0.05 MPa | 0.05 MPa |
| | plating | | | | | bead | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-9 shows results of the tests in terms of Comparative Example 1 constructed similarly to the gasket 10 by forming zinc (Zn) plated layers in the thickness of 15 μm on both surfaces of a SUS301H stainless steel thin plate having the plate thickness of 0.2 mm by an electroplating process, and then forming a full bead on that steel plate. The surface hardness of the plated layer is also too high in this Comparative Example 1. Accordingly, it is not possible to obtain a sufficient sealing effect and to ensure a favorable sealing property.

TABLE 3-9
(p52)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Comparative | Zn | 15 μm | electroplating | SUS301H | 0.2 mm | full | 0.25 mm | 0.35 MPa | 0.40 MPa |
| Example 1 | plating | | | | | bead | | | |
| Comparative | no surface | | — | SUS301H | 0.2 mm | full | 0.25 mm | 0.15 MPa | 0.20 MPa |
| Example 2 | coating | | | | | bead | | | |
| Comparative | rubber | 25 μm | — | SUS301H | 0.2 mm | full | 0.25 mm | 3.45 MPa | 0.95 MPa |
| Example 3 | coating | | | | | bead | | | |

Table 3-10 shows results of the tests in terms of Specimen 1 constructed similarly to the gasket 10 by forming tin-copper (Sn—Cu 2%) alloy plated layers in the thickness of 25 μm on both surfaces of a SUS301H stainless steel thin plate having the plate thickness of 0.2 mm by an molten metal plating process, and then forming a full bead on that steel plate. According to this Specimen 1, it is possible to ensure a stable sealing property both in the initial state prior to the thermal degradation test and after the thermal degradation test.

TABLE 3-10
(p54)

| | | | | Metal thin plate | | | | Sealing property | |
|---|---|---|---|---|---|---|---|---|---|
| | Surface coating | | | base material | | | | | After |
| | | Layer | | | Plate | Bead shape | | Initial | thermal |
| No. | Material | thickness | Plating method | Material | thickness | Shape | Height | state | degradation |
| Specimen 1 | Sn—Cu | 25 μm | molten metal | SUS301H | 0.2 mm | full | 0.25 mm | 2.75 MPa | 2.55 MPa |
| | plating | | plating | | | bead | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-11 shows results of the tests in terms of Specimen 1 constructed similarly to the gasket 10 by forming copper-silver (Cu—Ag 5%) alloy plated layers in the thickness of 30 μm on both surfaces of a SUS301H stainless steel thin plate having the plate thickness of 0.2 mm by an molten metal plating process, and then forming a full bead on that steel plate. According to this Specimen 1, it is possible to ensure a stable sealing property both in the initial state prior to the thermal degradation test and after the thermal degradation test.

TABLE 3-11
(p56)

| | | | | Metal thin plate | | | | Sealing property | |
|---|---|---|---|---|---|---|---|---|---|
| | Surface coating | | | base material | | | | | After |
| | | Layer | | | Plate | Bead shape | | Initial | thermal |
| No. | Material | thickness | Plating method | Material | thickness | Shape | Height | state | degradation |
| Specimen 1 | Cu—Ag | 30 μm | molten metal | SUS301H | 0.2 mm | full | 0.25 mm | 2.30 MPa | 2.25 MPa |
| | plating | | plating | | | bead | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-12 shows results of the tests in terms of Specimen 1 constructed similarly to the gasket 10 by firstly forming copper plated layers in the thickness of 10 μm as the base layers on both surfaces of a SUS301H stainless steel thin plate having the plate thickness of 0.2 mm, then forming tin plated layers thereon in the thickness of 10 μm as the surface layers respectively by electroplating processes, and then forming a full bead on that steel plate. According to this Specimen 1, it is possible to ensure a stable sealing property both in the initial state prior to the thermal degradation test and after the thermal degradation test.

TABLE 3-12
(p58)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Cu | 10 μm | electroplating | SUS301H | 0.2 mm | full | 0.25 mm | 3.05 MPa | 2.85 MPa |
| | plating | | | | | bead | | | |
| | Sn | 10 μm | | | | | | | |
| | plating | | | | | | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-13 shows results of the tests in terms of Specimen 1 constructed similarly to the gasket 10 by firstly forming copper plated layers in the thickness of 15 μm as the base layers on both surfaces of a SUS301H stainless steel thin plate having the plate thickness of 0.2 mm, then forming silver plated layers thereon in the thickness of 10 μm as the surface layers respectively by electroplating processes, and then forming a full bead on that steel plate. According to this Specimen 1, it is possible to ensure a stable sealing property both in the initial state prior to the thermal degradation test and after the thermal degradation test.

TABLE 3-13
(p60)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Cu | 15 μm | electroplating | SUS301H | 0.2 mm | full | 0.25 mm | 2.30 MPa | 2.15 MPa |
| | plating | | | | | bead | | | |
| | Ag | 10 μm | | | | | | | |
| | plating | | | | | | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-14 shows results of the tests in terms of Specimen 1 constructed similarly to the gasket 10 by firstly forming nickel (Ni) plated layers in the thickness of 8 μm as the base layers on both surfaces of a SUS301H stainless steel thin plate having the plate thickness of 0.2 mm, then forming tin plated layers thereon in the thickness of 20 μm as the surface layers respectively by electroplating processes, and then forming a full bead on that steel plate. According to this Specimen 1, it is possible to ensure a stable sealing property both in the initial state prior to the thermal degradation test and after the thermal degradation test.

TABLE 3-14
(p62)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Ni | 8 μm | electroplating | SUS301H | 0.2 mm | full | 0.25 mm | 3.05 MPa | 3.10 MPa |
| | plating | | | | | bead | | | |
| | Sn | 20 μm | | | | | | | |
| | plating | | | | | | | | |
| Comparative | no surface | | — | SUS301H | 0.2 mm | full | 0.25 mm | 0.15 MPa | 0.20 MPa |
| Example 1 | coating | | | | | bead | | | |
| Comparative | rubber | 25 μm | — | SUS301H | 0.2 mm | full | 0.25 mm | 3.45 MPa | 0.95 MPa |
| Example 2 | coating | | | | | bead | | | |

Table 3-15 shows results of the tests in terms of Specimen 1 constructed similarly to the gasket 10 by forming tin plated layers in the thickness of 25 μm on both surfaces of a SUS301H stainless steel thin plate having the plate thickness of 0.25 mm by an electroplating process, and then forming a half bead on that steel plate. According to this Specimen 1, it is possible to ensure a stable sealing property both in the initial state prior to the thermal degradation test and after the thermal degradation test.

TABLE 3-15
(p64)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |

| | | | | | | | | | |
|---|---|---|---|---|---|---|---|---|---|
| Specimen 1 | Sn | 25 μm | electoplating | SUS301H | 0.2 mm | full | 0.25 mm | 1.30 MPa | 1.15 MPa |
| | plating | | | | | bead | | | |

| Comparative | no surface | | — | SUS301H | 0.2 mm | full | 0.25 mm | 0.05 MPa | 0.05 MPa |
|---|---|---|---|---|---|---|---|---|---|
| Example 1 | coating | | | | | bead | | | |
| Comparative | rubber | 25 μm | — | SUS301H | 0.2 mm | full | 0.25 mm | 1.55 MPa | 0.40 MPa |
| Example 2 | coating | | | | | bead | | | |

Table 3-16 shows results of the tests in terms of Specimen 1 constructed similarly to the gasket 10 by forming tin plated layers in the thickness of 25 μm on both surfaces of a SUS304H stainless steel thin plate having the plate thickness of 0.2 mm by an electroplating process, and then forming a full bead on that steel plate. According to this Specimen 1, it is possible to ensure a stable sealing property both in the initial state prior to the thermal degradation test and after the thermal degradation test.

TABLE 3-16
(p66)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |
| Specimen 1 | Sn | 25 μm | electroplating | SUS304 | 0.2 mm | full bead | 0.25 mm | 0.65 MPa | 0.45 MPa |
| | plating | | | | | | | | |
| Comparative | no surface | | — | SUS304 | 0.2 mm | full bead | 0.25 mm | 0.01 MPa | 0.01 MPa |
| Example 1 | coating | | | | | | | | |
| Comparative | rubber | 25 μm | — | SUS304 | 0.2 mm | full bead | 0.25 mm | 0.70 MPa | 0.20 MPa |
| Example 2 | coating | | | | | | | | |

Table 3-17 shows results of the tests in terms of Specimen 1 constructed similarly to the gasket 10 by forming tin plated layers in the thickness of 25 μm on both surfaces of a SPCC thin steel plate having the plate thickness of 0.2 mm by an electroplating process, and then forming a full bead on that steel plate. According to this Specimen 1, it is possible to ensure a stable sealing property both in the initial state prior to the thermal degradation test and after the thermal degradation test.

TABLE 3-17
(p68)

| | | | | Metal thin plate | | | | Sealing property | |
|---|---|---|---|---|---|---|---|---|---|
| | Surface coating | | | base material | | | | | After |
| | | Layer | Plating | | Plate | Bead shape | | Initial | thermal |
| No. | Material | thickness | method | Material | thickness | Shape | Height | state | degradation |

| | | | | | | | | | |
|---|---|---|---|---|---|---|---|---|---|
| Specimen 1 | Sn | 25 μm | electroplating | SPCC | 0.2 mm | full bead | 0.25 mm | 0.45 MPa | 0.30 MPa |
| | plating | | | | | | | | |

| Comparative | no surface | | — | SPCC | 0.2 mm | full bead | 0.25 mm | 0.01 MPa | 0.01 MPa |
|---|---|---|---|---|---|---|---|---|---|
| Example 1 | coating | | | | | | | | |
| Comparative | rubber | 25 μm | — | SPCC | 0.2 mm | full bead | 0.25 mm | 0.50 MPa | 0.15 MPa |
| Example 2 | coating | | | | | | | | |

As described above, according to the metal gaskets of the respective examples including the soft metal plated layers 7 similar to the aforementioned specimens, it is apparent that high sealing properties and high heat resistance can be exerted.

Although this invention has been described based on the illustrated examples, it is to be noted that this invention will not be limited only to the above-described examples. For example, it is possible to omit the auxiliary plate 3 or to form a single plate type by use of the single base plate 2. Moreover, it is also possible to form the soft surface metal-plated layer 7 only on surfaces facing outside (the surfaces opposed to the deck surfaces of the cylinder block and the cylinder head) of the two base plates 2 instead of the both surfaces of the respective base plates 2. Moreover, the soft surface metal-plated layer 7 only needs to be configured to cover at least the respective annular beads 2b, and it is not always necessary to cover the entire surfaces of the base plates 2.

### INDUSTRIAL APPLICABILITY

As described above, according to this invention, it is possible to provide an excellent metal gasket, which is low in price and high in the freedom in controlling an amount of a step.

1. A metal gasket for a cylinder head comprising:
two base plates (2) respectively made of metal plates and layered over each other, each of said base plates (2) including cylinder holes (2a) formed so as to correspond to respective cylinder bores on a cylinder block of an internal combustion engine, annular beads (2b) of an angled cross-sectional shape formed around said respective cylinder holes, coolant holes (2c) formed on outer peripheral portions of said respective annular beads so as to correspond to coolant jackets on said cylinder block and to coolant holes on a cylinder head of said internal combustion engine, and an outer peripheral bead (2d) having a cross-sectional shape sloping on one side and being formed in a position so as to totally surround said annular beads and said coolant holes;
an auxiliary plate (3) made of a metal plate and interposed between said two base plates; and
a hard metal-plated layer (5) formed on at least one surface of said auxiliary plate and configured to extend from a position more radially inward than said annular bead to a position radially outward so as to overlap each of said annular beads of said base plate and to face a top portion of said annular bead, and thereby to surround each of said cylinder holes on said base plate annularly.

2. The metal gasket for a cylinder head according to claim 1,
wherein an annular bead having an angled cross-sectional shape is formed on said auxiliary plate so as to overlap said annular bead on said base plate and to allow top positions to face each other.

3. A metal gasket for a cylinder head comprising:
two base plates (2) respectively made of metal plates and layered over each other, each of said base plates (2) including cylinder holes (2a) formed so as to correspond to respective cylinder bores on a cylinder block of an internal combustion engine, annular beads (2b) of an angled cross-sectional shape formed around said respective cylinder holes, coolant holes (2c) formed on outer peripheral portions of said respective annular beads so as to correspond to coolant jackets on said cylinder block and to coolant holes on a cylinder head of said internal combustion engine, and an outer peripheral bead (2d) having a cross-sectional shape sloping on one side and being formed in a position so as to totally surround said annular beads and said coolant holes; and
a hard metal-plated layer (5) formed on either one or both of said two base plates on a surface facing the other base plate and configured to extend from a position more radially inward than said annular bead to a position radially outward so as to overlap each of said annular beads of said base plate and to face a top portion of said annular bead, and thereby to surround each of said cylinder holes on said base plate annularly.

4. The metal gasket for a cylinder head according to claim 1,
wherein said hard metal-plated layer (5) is made of any of nickel, nickel-phosphorus, and copper, and has hardness equal to or above Hv 60.

5. The metal gasket for a cylinder head according to claim 1,
wherein distribution of an amount of a step of said hard metal-plated layer relevant to said plurality of cylinder holes (2a) corresponds to distribution of rigidity of said internal combustion engine relevant to said plurality of cylinder bores.

6. A metal gasket for a cylinder head comprising:
two base plates (2) respectively made of metal plates and layered over each other, each of said base plates (2) including cylinder holes (2a) formed so as to correspond to respective cylinder bores on a cylinder block of an internal combustion engine, annular beads (2b) of an angled cross-sectional shape formed around said respective cylinder holes, coolant holes (2c) formed on outer peripheral portions of said respective annular beads so as to correspond to coolant jackets on said cylinder block and to coolant holes on a cylinder head of said internal combustion engine, and an outer peripheral bead (2d) having a cross-sectional shape sloping on one side and being formed in a position so as to totally surround said annular beads and said coolant holes;
an auxiliary plate (3) made of a metal plate and interposed between said two base plates;
a metal foil layer (5) made of a metal foil (6) to be attached onto at least one surface of said auxiliary plate and configured to extend from a position more radially inward than said annular bead to a position radially outward so as to overlap each of said annular beads of said base plate and to face a top portion of said annular bead and thereby to surround each of said cylinder holes on said base plate annularly; and
an adhesive layer (7) made of an adhesive to attach said metal foil to said auxiliary plate while at least being pressurized.

7. The metal gasket for a cylinder head according to claim 6,
wherein an annular bead having an angled cross-sectional shape is formed on said auxiliary plate so as to overlap said annular bead on said base plate and to allow top positions to face each other.

8. A metal gasket for a cylinder head comprising:
two base plates (2) respectively made of metal plates and layered over each other, each of said base plates (2) including cylinder holes (2a) formed so as to correspond to respective cylinder bores on a cylinder block of an internal combustion engine, annular beads (2b) of an angled cross-sectional shape formed around said respective cylinder holes, coolant holes (2c) formed on outer peripheral portions of said respective annular beads so as to correspond to coolant jackets on said cylinder block and to coolant holes on a cylinder head of said internal combustion engine, and an outer peripheral bead (2d) having a cross-sectional shape sloping on one side and being formed in a position so as to totally surround said annular beads and said coolant holes;
a metal foil layer (5) made of a metal foil (6) to be attached onto any of one and both of said two base plates on a surface facing the other base plate, and configured to extend from a position more radially inward than said annular bead to a position radially outward so as to overlap each of said annular beads of said base plate and to face a top portion of said annular bead, and thereby to surround each of said cylinder holes on said base plate annularly; and
an adhesive layer (7) made of an adhesive to attach said metal foil to said auxiliary plate while at least being pressurized.

9. The metal gasket for a cylinder head according to claim 6,
wherein said metal foil (6) is made of any of aluminum, an aluminum alloy, steel, stainless steel, bronze, titanium, and nickel, and has hardness equal to or above Hv 60.

10. The metal gasket for a cylinder head according to claim 6,
wherein said adhesive for said adhesive layer (7) is made of any of phenol, epoxy, and polyimide, or a combination of at least two types of these materials.

11. A metal gasket for a cylinder head comprising:
two base plates (2) respectively made of metal plates and layered over each other, each of said base plates (2) including cylinder holes (2a) formed so as to correspond to respective cylinder bores on a cylinder block of an internal combustion engine, annular beads (2b) of an angled cross-sectional shape formed around said respective cylinder holes, coolant holes (2c) formed on outer peripheral portions of said respective annular beads so as to correspond to coolant jackets on said cylinder block and to coolant holes on a cylinder head of said internal combustion engine, and an outer peripheral bead (2d) having a cross-sectional shape sloping on one side and being formed in a position so as to totally surround said annular beads and said coolant holes; and
soft surface metal-plated layers (7) formed on at least outer surfaces of said two base plates so as to cover at least said respective annular beads.

12. A metal gasket for a cylinder head comprising:
a single base plate (2) made of a metal plate and including cylinder holes (2a) formed so as to correspond to respective cylinder bores on a cylinder block of an internal combustion engine, annular beads (2b) of an angled cross-sectional shape formed around said respective cylinder holes, coolant holes (2c) formed on outer peripheral portions of said respective annular beads so as to correspond to coolant jackets on said cylinder block and to coolant holes on a cylinder head of said internal combustion engine, and an outer peripheral bead (2d) having a cross-sectional shape sloping on one side and being formed in a position so as to totally surround said annular beads and said coolant holes; and
soft surface metal-plated layers (7) formed on both surfaces of said base plate so as to cover at least said respective annular beads.

13. The metal gasket for a cylinder head according to claim 11,
wherein said soft surface metal-plated layer (7) is formed as any of a single layer and a plurality of layers using any of tin, copper, silver, and alloys thereof, and has surface hardness equal to or below Hv 60.

14. The metal gasket for a cylinder head according to claim 11,
wherein a thickness of said soft surface metal-plated layer (7) is set in a range from 3 μm to 40 μm inclusive.

15. The metal gasket for a cylinder head according to claim 2,
wherein said hard metal-plated layer (5) is made of any of nickel, nickel-phosphorus, and copper, and has hardness equal to or above Hv 60.

16. The metal gasket for a cylinder head according to claim 3,
wherein said hard metal-plated layer (5) is made of any of nickel, nickel-phosphorus, and copper, and has hardness equal to or above Hv 60.

17. The metal gasket for a cylinder head according to claim 2,
wherein distribution of an amount of a step of said hard metal-plated layer relevant to said plurality of cylinder holes (2a) corresponds to distribution of rigidity of said internal combustion engine relevant to said plurality of cylinder bores.

18. The metal gasket for a cylinder head according to claim 3,
wherein distribution of an amount of a step of said hard metal-plated layer relevant to said plurality of cylinder holes (2a) corresponds to distribution of rigidity of said internal combustion engine relevant to said plurality of cylinder bores.

19. The metal gasket for a cylinder head according to claim 7,
wherein said metal foil (6) is made of any of aluminum, an aluminum alloy, steel, stainless steel, bronze, titanium, and nickel, and has hardness equal to or above Hv 60.

20. The metal gasket for a cylinder head according to claim 8,
wherein said metal foil (6) is made of any of aluminum, an aluminum alloy, steel, stainless steel, bronze, titanium, and nickel, and has hardness equal to or above Hv 60.
